(19) United States
(12) Patent Application Publication
(10) Pub. No.: US 2026/0304489 A1
(43) Pub. Date: Oct. 1, 2026

(54) RANDOM ACCESS CHANNEL (RACH) CONFIGURATION ADAPTATION UTILIZING A VIRTUAL RACH CONFIGURATION

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Hung Dinh LY, San Diego, CA (US)

(21) Appl. No.: 19/091,573

(22) Filed: Mar. 26, 2025

(51) Int. Cl. H04W 74/0833; H04W 72/0446; H04W 72/21

(52) U.S. Cl. CPC H04W 74/0833; H04W 72/0446; H04W 72/21

(57) ABSTRACT

Certain aspects of the present disclosure provide techniques for random access channel (RACH) configuration and adaptation. A method, by a user equipment (UE), generally includes receiving, for a first uplink bandwidth part (BWP) that is an active uplink BWP of the UE, an indication of a virtual RACH configuration associated with one or more virtual RACH occasions (ROs); receiving a RACH configuration adaptation indication for the virtual RACH configuration, wherein the RACH configuration adaptation indication is associated with one or more additional ROs; and performing one or more actions to initiate a RACH procedure, wherein the action(s) comprise: transmitting a random access message in a first additional RO of the one or more additional ROs; or switching the active uplink BWP of the UE from the first uplink BWP to an initial uplink BWP and transmitting the random access message in an RO configured for the initial uplink BWP.

### INTRODUCTION

### Field of the Disclosure

Aspects of the present disclosure relate to wireless communications, and more particularly, to techniques for random access channel (RACH) configuration and adaptation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes receiving, for a first uplink BWP that is an active uplink bandwidth part (BWP) of the UE, an indication of a virtual random access channel (RACH) configuration associated with one or more virtual RACH occasions (ROs); receiving a RACH configuration adaptation indication for the virtual RACH configuration, wherein the RACH configuration adaptation indication is associated with one or more additional ROs; and performing one or more actions to initiate a RACH procedure, wherein the one or more actions comprise: transmitting a random access message in a first additional RO of the one or more additional ROs; or switching the active uplink BWP of the UE from the first uplink BWP to an initial uplink BWP and transmitting the random access message in another RO configured for the initial uplink BWP.

Another aspect provides one or more apparatuses configured for wireless communications. The one or more apparatuses include one or more processing systems that include one or more processors and one or more memories coupled with the one or more processors. The one or more processing systems are configured to cause the one or more apparatuses to receive, for a first uplink BWP that is an active uplink BWP of the UE, an indication of a virtual RACH configuration associated with one or more virtual ROs; receive a RACH configuration adaptation indication for the virtual RACH configuration, wherein the RACH configuration adaptation indication is associated with one or more additional ROs; and perform one or more actions to initiate a RACH procedure, wherein the one or more actions comprise: transmitting a random access message in a first additional RO of the one or more additional ROs; or switching the active uplink BWP of the UE from the first uplink BWP to an initial uplink BWP and transmitting the random access message in an RO configured for the initial uplink BWP.

Another aspect provides one or more apparatuses configured for wireless communications. The one or more apparatuses include means for receiving, for a first uplink BWP that is an active uplink BWP of the UE, an indication of a virtual RACH configuration associated with one or more virtual ROs; means for receiving a RACH configuration adaptation indication for the virtual RACH configuration, wherein the RACH configuration adaptation indication is associated with one or more additional ROs; and means for performing one or more actions to initiate a RACH procedure, wherein the means for performing the one or more actions comprise: means for transmitting a random access message in a first additional RO of the one or more additional ROs; or means for switching the active uplink BWP of the UE from the first uplink BWP to an initial uplink BWP and means for transmitting the random access message in an RO configured for the initial uplink BWP.

Another aspect provides one or more non-transitory computer-readable media. The one or more non-transitory computer-readable media include executable instructions that, when executed by one or more processors of one or more apparatuses, cause the one or more apparatuses to receive, for a first uplink BWP that is an active uplink BWP of the UE, an indication of a virtual RACH configuration associated with one or more virtual ROs; receive a RACH configuration adaptation indication for the virtual RACH configuration, wherein the RACH configuration adaptation indication is associated with one or more additional ROs; and perform one or more actions to initiate a RACH procedure, wherein the one or more actions comprise: transmitting a random access message in a first additional RO of the one or more additional ROs; or switching the active uplink BWP of the UE from the first uplink BWP to an initial uplink BWP and transmitting the random access message in an RO configured for the initial uplink BWP

Some examples of the methods, apparatuses, and non-transitory computer-readable media described herein may further include operations, features, means, or instructions for receiving an indication to initiate the RACH procedure, wherein performing the one or more actions is based on the indication.

In some examples of the methods, apparatuses, and non-transitory computer-readable media described herein, the indication to initiate the RACH procedure excludes any indication to use the one or more virtual ROs or the one or more additional ROs to initiate the RACH procedure; and the one or more actions comprise transmitting the random access message in the first additional RO of the one or more additional ROs.

In some examples of the methods, apparatuses, and non-transitory computer-readable media described herein, the indication to initiate the RACH procedure comprises an indication to use the one or more additional ROs to initiate the RACH procedure; and the one or more actions comprise transmitting the random access message in the first additional RO of the one or more additional ROs.

In some examples of the methods, apparatuses, and non-transitory computer-readable media described herein, the indication to initiate the RACH procedure comprises an indication to use the one or more virtual ROs to initiate the RACH procedure; and the one or more actions comprise transmitting the random access message in the first additional RO of the one or more additional ROs.

In some examples of the methods, apparatuses, and non-transitory computer-readable media described herein, the indication to initiate the RACH procedure comprises an indication to use the one or more virtual ROs to initiate the RACH procedure; and the one or more actions comprise: switching the active uplink BWP of the UE from the first uplink BWP to the initial uplink BWP; and transmitting the random access message in the RO configured for the initial uplink BWP.

Some examples of the methods, apparatuses, and non-transitory computer-readable media described herein may further include operations, features, means, or instructions for receiving, for the initial uplink BWP, an indication of a legacy RACH configuration associated with one or more legacy ROs comprising at least the RO.

Some examples of the methods, apparatuses, and non-transitory computer-readable media described herein may further include operations, features, means, or instructions for adapting the virtual RACH configuration to activate at least the first additional RO of the one or more additional ROs based on the RACH configuration adaptation indication.

In some examples of the methods, apparatuses, and non-transitory computer-readable media described herein, the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the first subset of the plurality of additional ROs or the second subset of the plurality of additional ROs comprises the first additional RO; and adapting the virtual RACH configuration comprises activating the first subset of the plurality of additional ROs and the second subset of the plurality of additional ROs.

In some examples of the methods, apparatuses, and non-transitory computer-readable media described herein, the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the second subset of the plurality of additional ROs comprises the first additional RO; and adapting the virtual RACH configuration comprises activating the second subset of the plurality of additional ROs and not activating the first subset of the plurality of additional ROs.

In some examples of the methods, apparatuses, and non-transitory computer-readable media described herein, the one or more virtual ROs comprise a plurality of virtual ROs; the one or more additional ROs comprise a plurality of additional ROs; each additional RO of a first subset of the plurality of additional ROs overlaps, in a time domain and according to a first overlap type, a first subset of the plurality of virtual ROs; each additional RO of a second subset of the plurality of additional ROs overlaps, in a time domain and according to a second overlap type, a second subset of the plurality of virtual ROs; the first subset of the plurality of additional ROs comprises the first additional RO; and adapting the virtual RACH configuration comprises activating the first subset of the plurality of additional ROs and not activating the second subset of the plurality of additional ROs.

In some examples of the methods, apparatuses, and non-transitory computer-readable media described herein, the first additional RO: overlaps, in a time domain, a first virtual RO of the one or more virtual ROs; and is associated with a first SSB index.

Some examples of the methods, apparatuses, and non-transitory computer-readable media described herein may further include operations, features, means, or instructions for receiving signaling that configures the UE to activate at least the first additional RO based on one or more conditions.

In some examples of the methods, apparatuses, and non-transitory computer-readable media described herein, the one or more additional ROs are associated with one or more first association periods that are different than one or more second association periods associated with the one or more virtual ROs.

In some examples of the methods, apparatuses, and non-transitory computer-readable media described herein, the one or more additional ROs and the one or more virtual ROs are both associated with one or more association periods.

Another aspect provides a method for wireless communications by a network entity. The method includes transmitting an indication of a virtual RACH configuration for a first uplink BWP that is an active uplink BWP of a UE, wherein the virtual RACH configuration is associated with one or more virtual ROs; transmitting a RACH configuration adaptation indication for the virtual RACH configuration, wherein the RACH configuration adaptation indication is associated with one or more additional ROs; and receiving a random access message, that initiates a RACH procedure, in: a first additional RO of the one or more additional ROs; or an RO configured for an initial uplink BWP of the UE.

Another aspect provides one or more apparatuses configured for wireless communications. The one or more apparatuses include one or more processing systems that include one or more processors and one or more memories coupled with the one or more processors. The one or more processing systems are configured to cause the one or more apparatuses to transmit an indication of a virtual RACH configuration for a first uplink BWP that is an active uplink BWP of a UE, wherein the virtual RACH configuration is associated with one or more virtual ROs; transmit a RACH configuration adaptation indication for the virtual RACH configuration, wherein the RACH configuration adaptation indication is associated with one or more additional ROs; and receive a random access message, that initiates a RACH procedure, in: a first additional RO of the one or more additional ROs; or an RO configured for an initial uplink BWP of the UE.

Another aspect provides one or more apparatuses configured for wireless communications. The one or more apparatuses include means for transmitting an indication of a virtual RACH configuration for a first uplink BWP that is an active uplink BWP of a UE, wherein the virtual RACH configuration is associated with one or more virtual ROs; means for transmitting a RACH configuration adaptation indication for the virtual RACH configuration, wherein the RACH configuration adaptation indication is associated with one or more additional ROs; and means for receiving a random access message, that initiates a RACH procedure, in: a first additional RO of the one or more additional ROs; or an RO configured for an initial uplink BWP of the UE.

Another aspect provides one or more non-transitory computer-readable media. The one or more non-transitory computer-readable media include executable instructions that, when executed by one or more processors of one or more apparatuses, cause the one or more apparatuses to transmit an indication of a virtual RACH configuration for a first uplink BWP that is an active uplink BWP of a UE, wherein the virtual RACH configuration is associated with one or more virtual ROs; transmit a RACH configuration adaptation indication for the virtual RACH configuration, wherein the RACH configuration adaptation indication is associated with one or more additional ROs; and receive a random access message, that initiates a RACH procedure, in: a first additional RO of the one or more additional ROs; or an RO configured for an initial uplink BWP of the UE.

Some examples of the methods, apparatuses, and non-transitory computer-readable media described herein may further include operations, features, means, or instructions for transmitting an indication to initiate the RACH procedure; and receiving the random access message comprises receiving the random access message based on the indication.

In some examples of the methods, apparatuses, and non-transitory computer-readable media described herein, the indication to initiate the RACH procedure excludes any indication to use the one or more virtual ROs or the one or more additional ROs to initiate the RACH procedure; and receiving the random access message comprises receiving the random access message in the first additional RO of the one or more additional ROs.

In some examples of the methods, apparatuses, and non-transitory computer-readable media described herein, the indication to initiate the RACH procedure comprises an indication to use the one or more additional ROs to initiate the RACH procedure; and receiving the random access message comprises receiving the random access message in the first additional RO of the one or more additional ROs.

In some examples of the methods, apparatuses, and non-transitory computer-readable media described herein, the indication to initiate the RACH procedure comprises an indication to use the one or more virtual ROs to initiate the RACH procedure; and receiving the random access message comprises receiving the random access message in the first additional RO of the one or more additional ROs.

In some examples of the methods, apparatuses, and non-transitory computer-readable media described herein, the indication to initiate the RACH procedure comprises an indication to use the one or more virtual ROs to initiate the RACH procedure; and receiving the random access message comprises receiving the random access message in the RO configured for the initial uplink BWP of the UE.

Some examples of the methods, apparatuses, and non-transitory computer-readable media described herein may further include operations, features, means, or instructions for transmitting, for the initial uplink BWP, an indication of a legacy RACH configuration associated with one or more legacy ROs comprising at least the RO.

Some examples of the methods, apparatuses, and non-transitory computer-readable media described herein may further include operations, features, means, or instructions for adapting the virtual RACH configuration to activate at least the first additional RO of the one or more additional ROs based on the RACH configuration adaptation indication.

In some examples of the methods, apparatuses, and non-transitory computer-readable media described herein, the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the first subset of the plurality of additional ROs or the second subset of the plurality of additional ROs comprises the first additional RO; and adapting the virtual RACH configuration comprises activating the first subset of the plurality of additional ROs and the second subset of the plurality of additional ROs.

In some examples of the methods, apparatuses, and non-transitory computer-readable media described herein, the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the second subset of the plurality of additional ROs comprises the first additional RO; and adapting the virtual RACH configuration comprises activating the second subset of the plurality of additional ROs and not activate the first subset of the plurality of additional ROs.

In some examples of the methods, apparatuses, and non-transitory computer-readable media described herein, the one or more virtual ROs comprise a plurality of virtual ROs; the one or more additional ROs comprise a plurality of additional ROs; each additional RO of a first subset of the plurality of additional ROs overlaps, in a time domain and according to a first overlap type, a first subset of the plurality of virtual ROs; each additional RO of a second subset of the plurality of additional ROs overlaps, in a time domain and according to a second overlap type, a second subset of the plurality of virtual ROs; the first subset of the plurality of additional ROs comprises the first additional RO; and adapting the virtual RACH configuration comprises activating the first subset of the plurality of additional ROs and not activating the second subset of the plurality of additional ROs.

In some examples of the methods, apparatuses, and non-transitory computer-readable media described herein, the first additional RO: overlaps, in a time domain, a first virtual RO of the one or more virtual ROs; and is associated with a first SSB index.

Some examples of the methods, apparatuses, and non-transitory computer-readable media described herein may further include operations, features, means, or instructions for transmitting signaling that configures the UE to activate at least the first additional RO based on one or more conditions.

In some examples of the methods, apparatuses, and non-transitory computer-readable media described herein, the one or more additional ROs are associated with one or more first association periods that are different than one or more second association periods associated with the one or more virtual ROs.

In some examples of the methods, apparatuses, and non-transitory computer-readable media described herein, the one or more additional ROs and the one or more virtual ROs are both associated with one or more first association periods.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts an example four-step random access channel (RACH) procedure.

FIG. 5B depicts an example two-step RACH procedure.

FIG. 6A depicts a process flow for communications in a network between a network entity and a UE to configure and dynamically activate RACH occasions (ROs) in an uplink bandwidth part (BWP) of the UE.

FIG. 6B depicts an example legacy RACH configuration for an initial uplink BWP of a UE, as well as an example virtual RACH configuration and an example additional RACH configuration defined relative to the example virtual RACH configuration for a first uplink BWP of the UE.

FIG. 7 depicts example activation of additional ROs configured for an active uplink BWP of a UE.

FIG. 8A depicts example time periods associated with an example virtual RACH configuration and an example additional RACH configuration.

FIG. 8B depicts other example time periods associated with an example virtual RACH configuration and an example additional RACH configuration.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for configuring random access channel (RACH) occasions (ROs) (referred to herein as “additional ROs”), which may be activated and deactivated for random access communications. The additional ROs may correspond to one or more time and frequency resources (“time-frequency resources”) configured for performing a RACH procedure. In certain aspects, the additional ROs may be configured relative to ROs (also referred to as “virtual ROs”) of a virtual RACH configuration. For example, the additional ROs may be configured using an additional RACH configuration by adapting one or more parameters of the virtual RACH configuration. Similar to a legacy RACH configuration (described in detail below), the virtual RACH configuration may indicate fixed ROs, which may not adjust to changing network conditions, such as increased communications traffic. However, different from a legacy RACH configuration, the ROs may include “virtual ROs,” which may appear, in essence, to be available for use by a user equipment (UE) for random access communications but may not correspond to any time-frequency resources scheduled for such communications. Put differently, the virtual ROs of the virtual RACH configuration may be configured to give the illusion that a baseline legacy RACH configuration exists, such that the additional ROs may be configured to achieve, at least in some cases, network energy savings. In certain aspects, the virtual RACH configuration and the additional RACH configuration may be configured for a same uplink bandwidth part (BWP) of a UE.

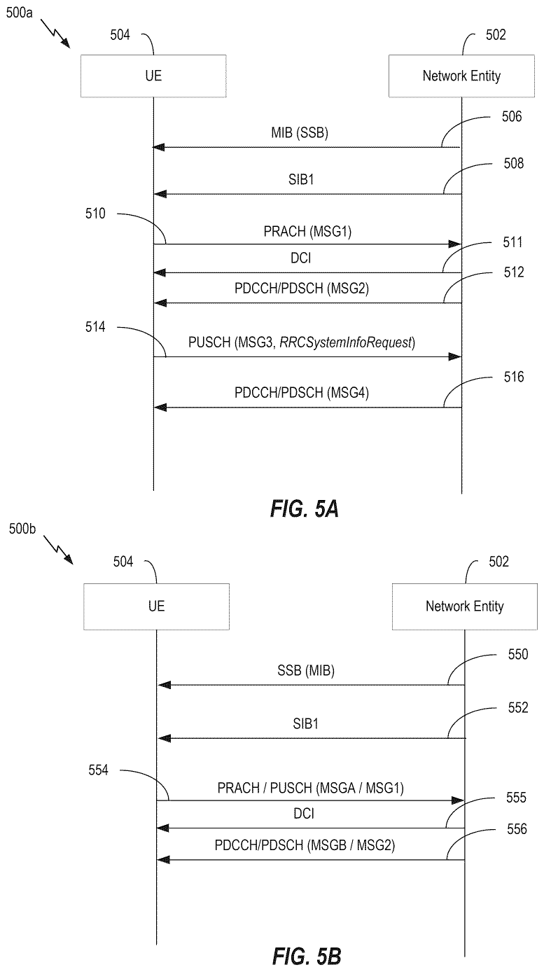

In certain wireless communication systems (e.g., 5G New Radio systems and/or any future wireless communications system), a UE may communicate with a network entity (e.g., a base station (BS)) using a RACH procedure, for example, for initial access to the network entity, for beam failure recovery, to obtain timing information (e.g., a timing advance), to request uplink communication resources, to request system information, etc. An example RACH procedure may begin with the UE transmitting a random access message (also referred to as a “random access signal”) (e.g., a preamble) on a physical RACH (PRACH) in an RO, which may include time-frequency resources. Upon successful reception of the random access message, the network entity may transmit a response (referred to as a “random access response”) to the random access message within a random access response window (e.g., a time window). For example, in certain aspects, the network entity may transmit a physical downlink control channel (PDCCH) communication including downlink control information (DCI) that schedules the random access response on a physical downlink shared channel (PDSCH). The random access response may include an uplink scheduling grant. On receiving the response, the UE may transmit a request to setup a connection with the network entity, and then, the network entity may reply with a contention resolution response. Certain aspects associated with random access communications are further described herein, for example, with respect to FIGS. 5A and 5B.

In certain aspects, a UE may obtain, from a network entity, a configuration for random access communications (also referred to herein as a “RACH configuration”), such as to perform a RACH procedure. For example, the UE may obtain the RACH configuration via system information that is broadcast by the network entity. The RACH configuration may identify certain parameters for random access communications, such as a set of preambles and/or a duration for the random access response window. Further, in certain aspects, the RACH configuration may identify ROs corresponding to time-frequency resources configured for random access communications, such as for a random access message transmission (e.g., preamble transmission) from the UE to the network entity.

A RACH configuration that configures multiple ROs for random access communications may help to reduce latency associated with accessing the network, such as by providing more opportunities for a UE to initiate a RACH procedure and thus establish a connection with a network entity. However, this improvement in network access time may be realized at the expense of lower energy savings for the network. For example, to save energy, a network entity may transition into a lower-power state (also referred to as a “sleep mode”) during one or more time periods, including time periods with minimal network traffic. A network entity may avoid entering into the lower-power state, however, when multiple ROs are configured during a time period. For example, to reduce the likelihood of missing a transmission from a UE, the network entity may remain in a higher-power state (also referred to as an “awake mode”), such as for extended periods of time (e.g., associated with the configured ROs), to monitor for and process random access messages, from one or more UEs, in the multiple configured ROs. Thus, network energy consumption may increase as a result of the reduced amount and/or duration of sleep periods for the network entity.

Accordingly, in an effort to increase network energy savings without impacting (or with minimal impact to) network access performance, some approaches introduce techniques for dynamically adapting ROs in a time domain. Dynamic adaptation of ROs in the time domain is a technique used to adjust the number of configured ROs that are available (e.g., activated) for random access communications, such as for a random access message transmission (e.g., preamble transmission) from a UE to a network entity. In certain aspects, dynamic adaptation of ROs may be used to increase a number of ROs that are available for random access communications, such as for a defined period of time. After the period of time, the ROs may no longer be available for random access communications (e.g., may be deactivated), thereby enabling a network entity to transition into a lower-power state (e.g., at least until a next-in-time RO).

For example, a UE may obtain multiple RACH configurations for random access communications, including a first RACH configuration and a second RACH configuration. The first RACH configuration may configure the UE with a first set of ROs that may be used for random access communications, and the second RACH configuration may configure the UE with a second set of ROs, which may be initially dormant and later activated (e.g., made available) for random access communications. In some examples, the first RACH configuration may be a “legacy RACH configuration” associated with fixed ROs (e.g., the first set of ROs), which may not adjust to changing network conditions, such as increased communication traffic. Further, the second RACH configuration may be an “additional RACH configuration,” associated with the legacy RACH configuration, which may be added to accommodate newer wireless devices (e.g., such as UEs that are configured for a current or future generation of wireless communications and that have advanced circuitry and/or processing capabilities) and/or varying network requirements, such as to improve efficiency and reduce unnecessary network energy consumption. For example, the additional RACH configuration may be associated with additional ROs in the time domain (e.g., the second set of ROs, associated with additional RACH resources), which may be activated and deactivated over time, such as in response to changing network traffic and/or access requests. Accordingly, the additional RACH configuration may represent an adaptation to the legacy RACH configuration, providing a flexible solution that helps to balance network efficiency and energy consumption, as needed.

In certain aspects, RACH configurations, such as a legacy RACH configuration or both legacy and additional RACH configurations, may be configured per BWP. As used herein, a “BWP” may refer to a designated portion of an overall bandwidth of a carrier (e.g., corresponding to a specific frequency band or channel) used for the communication of data. For example, a UE may be configured with multiple uplink BWPs, although only one uplink BWP may be active at the UE at a given time (e.g., while others are deactivated, such as to save power at the UE). Further, a first RACH configuration may configure the UE with a first set of ROs for one of the uplink BWPs (e.g., a first uplink BWP), and a second RACH configuration may configure the UE with a second set of ROs for another one of the uplink BWPs (e.g., a second uplink BWP). Thus, when the first uplink BWP of the UE is active, the UE may use the first set of ROs (and not use the second set of ROs) for random access communications. Further, when the second uplink BWP of the UE is active, the UE may use the second set of ROs (and not use the first set of ROs) for random access communications.

In some cases, a UE may be configured with a first uplink BWP that does not include any ROs (e.g., no legacy and/or additional ROs may be configured). Thus, when the first uplink BWP is active and the UE determines to perform a RACH procedure (e.g., such as autonomously or when triggered by higher layers), the UE may perform BWP switching to switch the active uplink BWP for the UE to a second uplink BWP having configured ROs. The UE may send a random access signal in at least one of the ROs configured in the second uplink BWP to initiate the RACH procedure. While this approach may allow a network entity to monitor fewer ROs (e.g., the network entity may not need to monitor any ROs in the first uplink BWP) for increased network energy savings, switching between uplink BWPs to initiate the RACH procedure may result in higher power consumption at the UE, as well as an increase in the latency experienced by the UE in accessing the network.

One technical solution to the aforementioned technical problem may include activating additional RO(s) in the first uplink BWP when the UE determines to initiate a RACH procedure while the first uplink BWP is the active uplink BWP of the UE. For example, instead of configuring the UE with legacy ROs in the first uplink BWP, the UE may be configured with additional ROs in the first uplink BWP that are initially dormant and later activated for performing the RACH procedure. Thus, network energy savings may continue to be realized and BWP switching may be avoided to help reduce power consumption and/or latency at the UE.

Technical problems associated with configuring a UE with additional ROs in an uplink BWP, without configuring the UE with legacy ROs in the uplink BWP, may be encountered at least due to the fact that an additional RACH configuration is generally defined relative to a legacy RACH configuration. For example, a legacy RACH configuration may be configured with a set of parameters defining how a UE may access the network to establish an initial connection via a RACH. Example parameters may include a RACH configuration index (prach-ConfigurationIndex) specifying a timing for a UE to establish an uplink connection with the network, a msg-1 frequency division multiplexing (FDM) parameter (msg1-FDM) specifying a number of ROs allocated in the frequency domain within a single time slot (e.g., for multiplexed transmission), and a random access response window parameter (ra-ResponseWindow) specifying a time window where a UE may wait to receive a random access response, among others. An additional RACH configuration may be defined “relative to” the legacy RACH configuration based on adapting one or more parameters of the legacy RACH configuration. For example, in some cases, the additional RACH configuration may be configured with a RACH configuration index that is different than the legacy RACH configuration, and one or more other parameters similar to the legacy RACH configuration. As another example, in some cases, the additional RACH configuration may be configured with a same RACH configuration index as the legacy RACH configuration and one or more other parameters that differ from the legacy RACH configuration. Thus, the configuration of the additional ROs via the additional RACH configuration may rely on the initial configuration and existence of the legacy RACH configuration. For an uplink BWP that is not configured with a legacy RACH configuration, this presents a technical problem for configuring additional ROs in the uplink BWP.

Certain aspects of the present disclosure overcome the aforementioned technical problems associated with configuring additional ROs in an uplink BWP that is not configured with any legacy ROs (e.g., fixed ROs) for random access communications, and provide a technical benefit to the field of telecommunications. For example, certain aspects may allow for the configuration of additional ROs, in an uplink BWP, relative to a virtual RACH configuration associated with the uplink BWP. That is, a virtual RACH configuration may configure a UE with one or more virtual ROs in the uplink BWP. The virtual ROs, associated with the virtual RACH configuration, may appear, in essence, to be real and capable of being used by the UE for random access communications, but may not actually exist for such communications. Put differently, the virtual ROs may not correspond to any time-frequency resources that are scheduled and can be used for random access communications. Instead, the virtual ROs may be configured in the uplink BWP to give the illusion that a baseline RACH configuration (e.g., such as a legacy RACH configuration with fixed ROs) exists such that additional ROs may be configured in the uplink BWP. In certain aspects, the additional ROs may be configured in the uplink BWP by adapting one or more parameters of the virtual RACH configuration.

In certain aspects, the additional ROs, when initially configured, may be deactivated such that a network entity does not need to monitor these additional ROs for random access message(s) from the UE (e.g., used to initiate one or more RACH procedures). However, at a later time, one or more of the additional ROs may be activated and used for random access communications. For example, in certain aspects, the UE may receive a RACH configuration adaptation indication for the virtual RACH configuration. The RACH configuration adaptation indication may indicate the activation of the additional ROs. Activating the adaptation may (e.g., dynamically) adjust the RO(s) available for random access communications in the uplink BWP, such that one or more of the additional ROs are available for use by (e.g., activated for) the UE for communicating a subsequent random access message in the uplink BWP.

In certain aspects, the additional ROs that are activated (e.g., via the RACH configuration adaptation indication), and thus are available for use by the UE, may include all additional ROs configured in the uplink BWP (e.g., irrespective of whether or not these additional ROs overlap, in a time domain, virtual ROs of the virtual RACH configuration for the uplink BWP). In certain aspects, the additional ROs that are activated may include only ROs that do not overlap, in the time domain, any virtual ROs of the virtual RACH configuration for the uplink BWP (e.g., additional ROs that at least partially overlap any of the virtual ROs may be invalid and unavailable for use by the UE). In certain aspects, the additional ROs that are activated may include ROs that (1) overlap, in the time domain, any virtual RO of the virtual RACH configuration for the uplink BWP and (2) satisfy one or more conditions (e.g., have a specific overlap type, etc.).

In certain aspects, such as after the activation of one or more of the additional ROs in the uplink BWP, the UE may send a random access message in one of the additional ROs that has been activated for random access communications. The UE may send the random access message to initiate a RACH procedure in the uplink BWP. In certain aspects, the UE may send the random access message based on receiving an indication to initiate the RACH procedure. In certain other aspects, the UE may send the random access message based on autonomously determining (e.g., without outside influence) to initiate the RACH procedure.

In certain other aspects where the UE receives an indication to initiate a RACH procedure, the UE may perform BWP switching to switch its active uplink BWP to an initial uplink BWP. The UE may then use a legacy RO configured for the initial uplink BWP to transmit a random access message and thereby initiate the RACH procedure.

Certain techniques for RACH configuration adaptation, utilizing a virtual RACH configuration, described herein may provide various beneficial technical effects and/or advantages. For example, the techniques for RACH configuration adaptation, utilizing a virtual RACH configuration, may enable improved wireless communications performance, such as increased network energy savings, reduced power consumption at a UE, and reduced latency associated with a UE accessing a network. The increased network energy savings may be attributable to the use of the virtual RACH configuration described herein, for example, due to the virtual RACH configuration configuring virtual ROs, for an uplink BWP, that do not need to be monitored by a network entity, but do allow for additional ROs to be configured for the uplink BWP. The reduced power consumption and reduced latency at a UE may be attributable to configuring an uplink BWP with the virtual RACH configuration described herein. This may allow for an additional RACH configuration to also be configured (e.g., defined relative to the virtual RACH configuration) for the uplink BWP. This additional RACH configuration may be associated with additional ROs that may be activated and used by the UE, for example, when the UE determines to perform a RACH procedure, such that the UE can perform the RACH procedure in the current uplink BWP (e.g., a currently active BWP) and avoid needing to perform BWP switching (e.g., such as to switch to an initial uplink BWP configured with legacy ROs, which may be used for transmitting a random access message).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

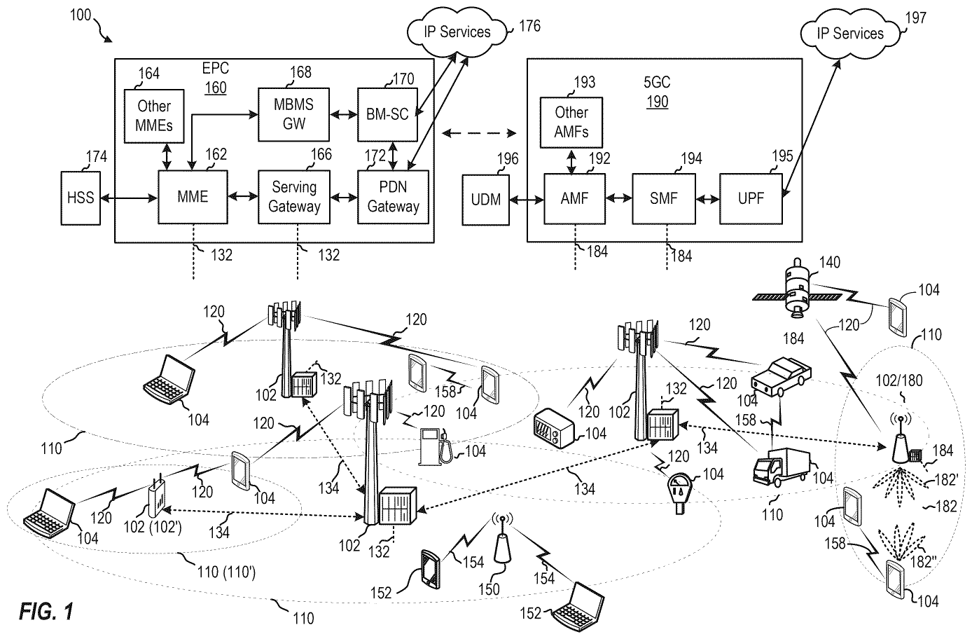

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

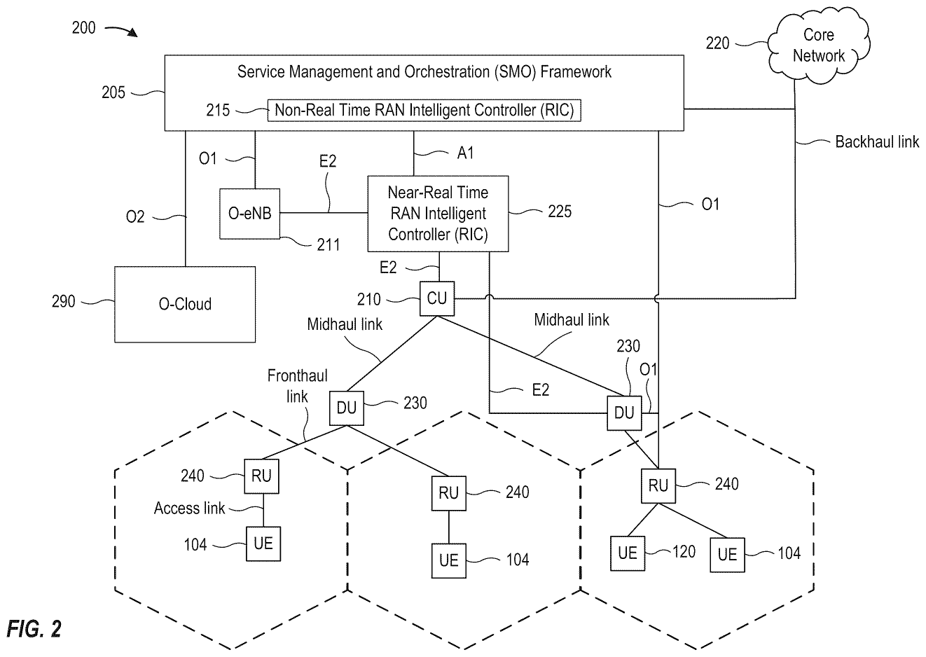

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

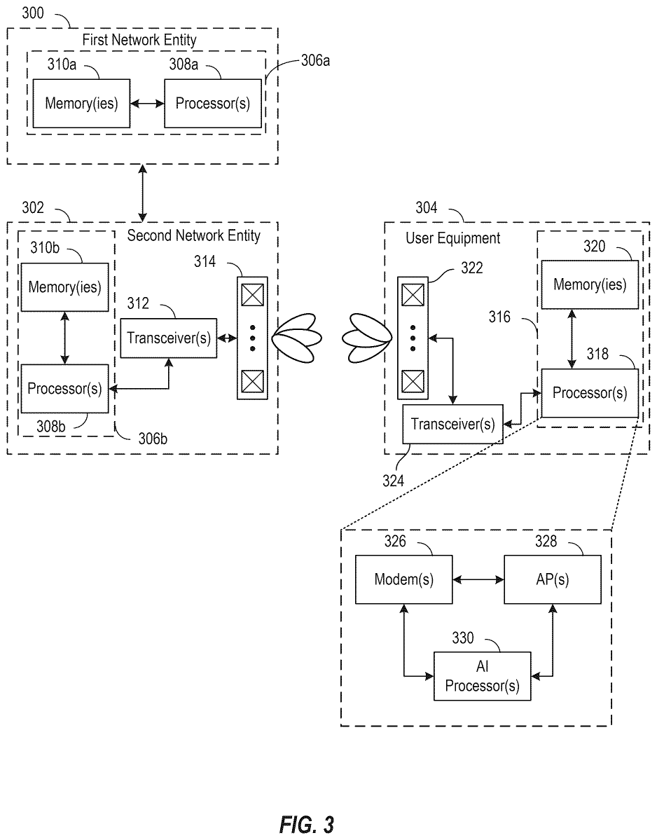

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

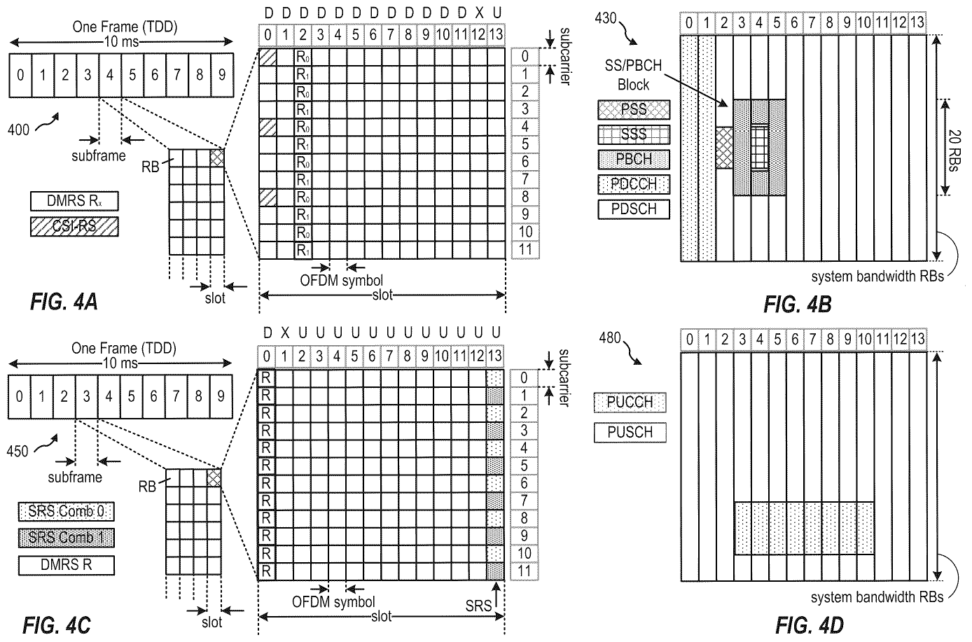

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example RACH Procedures

Certain wireless communication systems (e.g., a 5G NR system and/or any future wireless communications system) may provide a specified channel for random access, such as a RACH, and corresponding random access procedures, also referred to herein as “RACH procedures.” A RACH procedure may be performed for any of various events including, for example, initial access from an idle state, RRC connection re-establishment, handover, downlink and/or uplink data arrival (e.g., when the UE is in an idle state), or device positioning.

As used herein, RRC states of a UE in a RAN include (1) a connected state (also referred to as a “connected mode,” “RRC connected mode,” and/or “RRC connected state”), (2) an inactive state (also referred to as an “inactive mode,” “RRC inactive mode,” and/or “RRC inactive state”), and (3) an idle state (also referred to as an “idle mode,” “RRC idle mode,” and/or “RRC idle state”). The UE may be operating in a connected state in the RAN after establishing an RRC connection with a network entity in the RAN. The UE may be operating in an idle state in the RAN when the UE is not connected, or in other words, does not have an established RRC connection with the network entity in the RAN. The UE may be operating in an inactive state in the RAN when the UE has an established RRC connection with the network entity in the RAN, but the connection is in a dormant, suspended, or inactive and there is no active communication between the UE and the network entity. For example, while operating in the inactive state, unlike the idle state, a non-access stratum (NAS) layer of an RRC connection established by the UE may continue to be connected.

FIG. 5A depicts a process flow diagram of an example RACH procedure 500a (referred to as a “four-step RACH procedure”) performed between a UE 504 and a network entity 502. In some aspects, the UE 504 is the UE 104 depicted and described with respect to FIGS. 1 and 3, and the network entity 502 is the base station 102 depicted and described with respect to FIGS. 1 and 3 or a disaggregated base station depicted and described with respect to FIG. 2.

The RACH procedure 500a may begin, at 506, with the network entity 502 broadcasting and the UE 504 receiving an MIB. The MIB may be carried by the PBCH, which, as described above, may be logically grouped with a PSS and a SSS to form a SS/PBCH block, which, in some cases, may be referred to as an SSB. The MIB may be the first, among other SIBs, which may also be broadcasted by network entity 502. The MIB may be a control channel message transmitted by network entity 502 that provides information for UE 504 to synchronize with the network and access a cell of network entity 502. Network entity 502 may transmit MIBs periodically.

The RACH procedure 500a then proceeds, at 508, with the network entity 502 broadcasting and the UE 504 receiving a SIB1. The SIB1 may carry basic information that UE 504 may use to perform initial attachment to the RAN and network entity 502.

At 510, the UE 504 sends a first message (MSG1) to the network entity 502 on a physical random access channel (PRACH). In some aspects, MSG1 may indicate or include a RACH preamble. The RACH preamble may indicate or include a preamble signature associated with the RACH preamble. The preamble signature may correspond to a particular preamble sequence (e.g., a Zaddoff Chu sequence) generated across time-frequency resources used for the preamble transmission. For contention-based random access (CBRA), the preamble sequence may be randomly selected among a set of preamble sequences (e.g., up to 64 sequences in some cases). The preamble signature may be used to identify the UE 504 for scheduling communications (e.g., MSG2 and MSG3) with the network entity 502. The term “RACH preamble” may refer to or correspond to “random access preamble,” “preamble,” “preamble sequence,” and/or “preamble signature.”

At 512, the network entity 502 responds with a random access response (RAR) message (MSG2). For example, in certain aspects, at 511, the network entity 502 may send a PDCCH communication including DCI that schedules the RAR on the PDSCH. The RAR message and the DCI that schedule the RAR are examples of a RAR-related message. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble signature and indicate that the RAR is for the UE 504 that transmitted MSG1 at 510. As an example, the RAPID may identify a particular frequency resource used for the preamble transmission. The backoff parameter value may be used to determine an RO for sending a subsequent RACH transmission (e.g., a preamble transmission). An RO may correspond to one or more time-frequency resources available for transmitting a preamble on a RACH.

At 514, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (e.g., for an UL transmission). As an example, MSG3 may use the time-frequency resource(s) indicated in the UL grant of the RAR. In some examples, MSG3 may include a bitmap of one or more requested SI messages.

At 516, the network entity 502 sends a contention resolution message (MSG4) in response to MSG3. In some cases, if the UE 504 is unable to receive or decode MSG3 and/or MSG4, the UE 504 may repeat RACH procedure 500a.

In some cases, to reduce the latency associated with random access, another RACH procedure may be used, such as a two-step RACH procedure instead of a four-step RACH procedure (e.g., RACH procedure 500a). As the name implies, the two-step RACH procedure may effectively consolidate the four messages of the four-step RACH procedure into two messages.

FIG. 5B depicts a process flow diagram of another example RACH procedure 500b (referred to as a “two-step RACH procedure”) performed between the UE 504 and the network entity 502. The RACH procedure 500b may optionally begin at 550, where the network entity 502 broadcasts and the UE 504 receives a MIB, for example within an SSB. Further, at 552, the network entity 502 broadcasts and the UE 504 receives a SIB1 (e.g., steps 550 and 552 in the RACH procedure 500b may be similar to steps 506 and 508 in the RACH procedure 500a). The SIB1 may include random access resources in SI-RequestConfig, where the RA resources are linked to requested SI messages.

At 554, the UE 504 sends a first message (MSG1 or MSGA) to the network entity 502, which may effectively combine MSG1 and MSG3 described above with respect to FIG. 5A. In some aspects, MSG1/MSGA includes a RACH preamble for random access and a payload. For example, the payload may include a UE-ID and other signaling information, such as a buffer status report and/or a scheduling request. The RACH preamble of MSG1/MSGA may be transmitted over the RACH, and the payload of MSGA may be transmitted over the PUSCH, for example.

At 556, the network entity 502 sends a random access response message (MSG2 or MSGB), which may effectively combine MSG2 and MSG4 described above with respect to FIG. 5A. For example, MSGB may include a RAPID. For example, in certain aspects, at 555, the network entity 502 may send a PDCCH communication including DCI that schedules the RAR on the PDSCH. The RAR message and the DCI that schedule the RAR are examples of a RAR-related messages.

In certain aspects, UE 504 obtains, from network entity 502, a RACH configuration to perform RACH procedure 500a or RACH procedure 500b. The RACH configuration may identify ROs corresponding to time-frequency resources configured for random access communications, such as for the transmission of the first message (MSG1) to the network entity 502 in RACH procedure 500a or the transmission of the first message (MSG1 or MSGA) to the network entity 502 in RACH procedure 500b. The ROs may be fixed, meaning that they may not adjust to varying network conditions (e.g., always active ROs).

In certain other aspects, UE 504 obtains, from network entity 502, multiple RACH configurations to perform RACH procedure 500a or RACH procedure 500b. In certain aspects, the multiple RACH configurations may include a first RACH configuration, or a “legacy RACH configuration,” and a second RACH configuration, or an “additional RACH configuration.” The legacy RACH configuration may configure the UE with a first set of ROs (e.g., legacy RO(s)), which may be fixed and used for random access communications, and the additional RACH configuration may configure the UE with a second set of ROs (e.g., additional RO(s)), which may be initially dormant and later activated (e.g., made available) for random access communications. For example, in certain aspects, the UE may receive a RACH configuration adaptation indication that indicates the activation of one or more of the additional ROs. Activation of the adaptation may (e.g., dynamically) adjust the RO(s) available for random access communications, such that one or more of the additional ROs are available for use by the UE (e.g., activated) for communicating a subsequent random access message.

In some cases, the RACH configuration adaptation indication may be communicated via DCI (referred to as “DCI-based adaptation”). DCI-based adaptation is one example technique that may be used to activate RO(s) of a RACH configuration for random access communications, such as additional RO(s) of an additional RACH configuration associated with (e.g., that is defined relative to) a legacy RACH configuration. DCI-based adaptation may activate additional RO(s) of the additional RACH configuration to increase the opportunities available for a UE to initiate a RACH procedure and thus establish a connection with a network entity. The UE may activate one or more additional ROs based on receiving the DCI, such that these RO(s) (in some cases, in addition to legacy RO(s)) are available for use by the UE to initiate a RACH procedure. Although certain aspects herein describe the use of DCI for RACH configuration adaptation, in some other examples, the adaptation may be triggered via semi-static configuration (e.g., via a SIB1), radio resource control (RRC) configuration, and/or other configuration.

An additional RACH configuration may be associated with a legacy RACH configuration, or more specifically, may be defined relative to the legacy RACH configuration. For example, the legacy RACH configuration may be configured with a set of parameters (e.g., prach-ConfigurationIndex, msg1-FDM, ra-ResponseWindow, etc.) defining how a UE may access the network to establish an initial connection via a RACH. The additional RACH configuration may be defined “relative to” the legacy RACH configuration based on adapting one or more parameters of the legacy RACH configuration. For example, in some cases, the additional RACH configuration may be configured with (1) a RACH configuration index (prach-ConfigurationIndex) that is different than the RACH configuration index (prach-ConfigurationIndex) configured for the legacy RACH configuration and (2) one or more other parameters that are the same as or different than other parameter(s) of the legacy RACH configuration. As another example, in some cases, the additional RACH configuration may be configured with (1) a same RACH configuration index (prach-ConfigurationIndex) as the legacy RACH configuration and (2) one or more other parameters that are the same as or different than other parameter(s) of the legacy RACH configuration. Thus, the configuration of the additional ROs via the additional RACH configuration may rely on the initial configuration and existence of the legacy RACH configuration.

In certain aspects, legacy RACH configurations may be configured per uplink BWP configured for a UE. For example, a first legacy RACH configuration may configure the UE with a first set of legacy ROs for a first uplink BWP of the UE. Further, a second legacy RACH configuration may configure the UE with a second set of legacy ROs for a second uplink BWP of the UE. Thus, when the first uplink BWP of the UE is active, the UE may use the first set of legacy ROs (and not use the second set of legacy ROs) for random access communications. Further, when the second uplink BWP of the UE is active, the UE may use the second set of legacy ROs (and not use the first set of legacy ROs) for random access communications.

In certain aspects, legacy RACH configurations, and associated additional RACH configurations, may be configured per uplink BWP of a UE. For example, a first legacy RACH configuration and a first additional RACH configuration (e.g., associated with the first legacy RACH configuration) may configure the UE with a first set of legacy ROs and a first set of additional ROs for a first uplink BWP of the UE. Further, a second legacy RACH configuration and a second additional RACH configuration (e.g., associated with the second legacy RACH configuration) may configure the UE with a second set of legacy ROs and a second set of additional ROs for a second uplink BWP of the UE. Thus, when the first uplink BWP of the UE is active, the UE may use the first set of legacy ROs and/or one or more additional ROs of the first set of additional ROs for random access communications, for example, where the additional ROs(s) have been activated (e.g., the first legacy RACH configuration has been “adapted” to include the additional RO(s)). Alternatively, when the second uplink BWP of the UE is active, the UE may use the second set of legacy ROs and/or one or more additional ROs of the second set of additional ROs for random access communications, for example, where the additional ROs(s) have been activated (e.g., the second legacy RACH configuration has been “adapted” to include the additional RO(s)).

In some cases, a UE may be configured with a first uplink BWP that does not include any ROs (e.g., no legacy and/or additional ROs may be configured). Thus, when the first uplink BWP is active and the UE determines to perform a RACH procedure (e.g., such as autonomously or when triggered by higher layers), the UE may perform BWP switching to switch the active uplink BWP for the UE to a second uplink BWP having configured ROs. The UE may send a random access message in at least one of the ROs configured in the second uplink BWP to initiate the RACH procedure. While this approach may allow a network entity to monitor fewer ROs (e.g., the network entity may not need to monitor any ROs in the first uplink BWP) for increased network energy savings, switching between uplink BWPs to initiate the RACH procedure may result in higher power consumption at the UE, as well as increase the latency experienced by the UE in accessing the network.

One technical solution to the aforementioned technical problems may include configuring additional ROs in the first uplink BWP and activating one or more of these additional ROs when the UE determines to initiate a RACH procedure while the first uplink BWP is the active uplink BWP of the UE. For example, by activating the additional RO(s), the UE may avoid performing BWP switching and thus be able to use one of the activated additional RO(s) in the first uplink BWP for sending a random access message. While this solution may help to reduce power consumption and/or latency associated with accessing the network, configuring additional ROs in the first uplink BWP may not be possible. For example, as described herein, an additional RACH configuration may be defined relative to an existing legacy RACH configuration. Thus, based on the first uplink BWP not including any legacy ROs (e.g., not being configured with a legacy RACH configuration), configuring the UE with additional RO(s) in the first uplink BWP may not be feasible.

### Aspects Related to RACH Configuration Adaptation Utilizing a Virtual RACH Configuration

Aspects described herein improve upon the state of the art by providing techniques for configuring additional ROs in an uplink BWP that is not configured with any legacy ROs (e.g., fixed ROs) for random access communications. For example, in certain aspects, a UE may receive signaling configuring the UE with one or more virtual ROs for an uplink BWP, such as a first uplink BWP, of the UE. The virtual RO(s) may appear, in essence, to correspond to time-frequency resources and be capable of being used for random access communications. However, the virtual RO(s) may not correspond to any time-frequency resources that are scheduled for random access communications, and thus, the UE may not use the virtual ROs for communicating with a network entity (e.g., to initiate a RACH procedure). Instead, the UE may be configured with the virtual RO(s) to create an illusion that a baseline, legacy RACH configuration exists for the first uplink BWP. The existence of the legacy RACH configuration may allow for the configuration of additional RO(s). For example, the UE may receive signaling configuring the UE with one or more additional ROs for the first uplink BWP. The one or more additional ROs may be associated with an additional RACH configuration defined relative to the virtual RACH configuration configured for the first uplink BWP of the UE.

In certain aspects, the UE may use one or more of the additional RO(s), configured for the first uplink BWP, for transmitting, in the first uplink BWP, a random access message to initiate a RACH procedure with a network entity. For example, the additional RO(s) may be activated, based on the UE receiving a RACH configuration adaptation indication, and further used for such random access communications with the network entity.

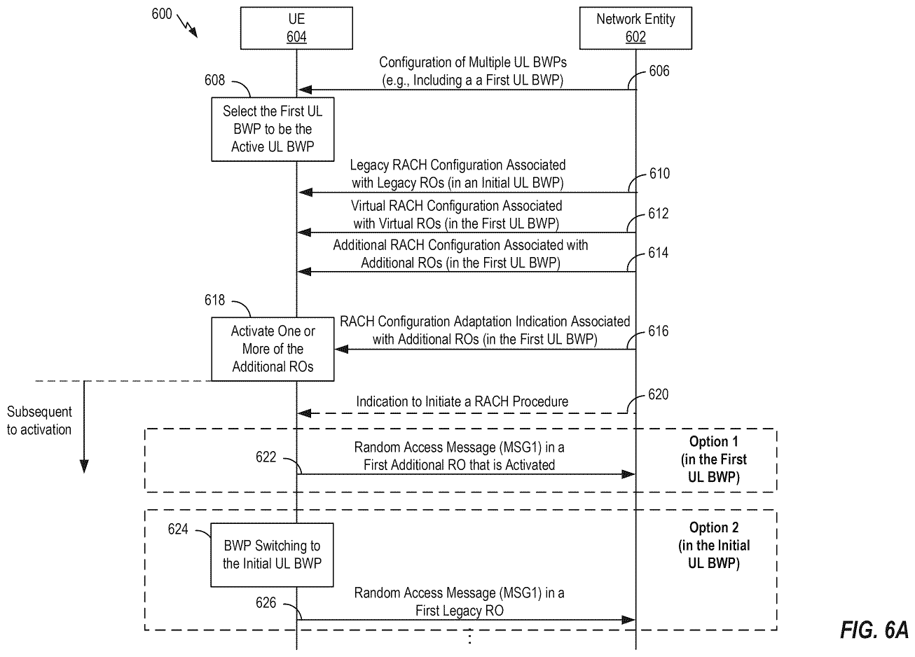

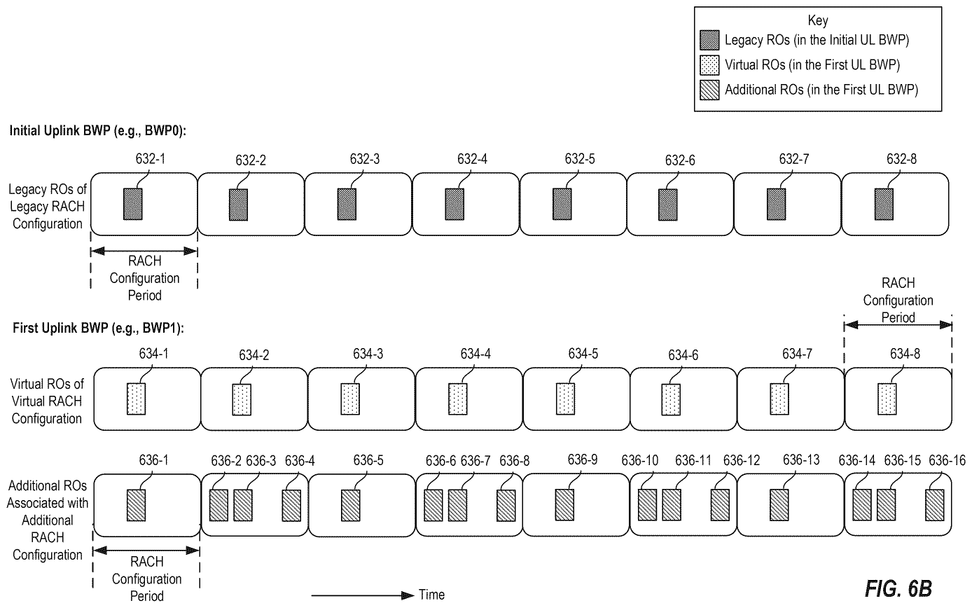

Additional details related to configuring a UE with a virtual RACH configuration and an additional RACH configuration for an uplink BWP, the activation of one or more additional ROs for random access communications in the uplink BWP, and the use of one of the activated additional ROs, in the uplink BWP, or another RO configured for an initial uplink BWP of the UE are provided below with respect to FIG. 6A.

### Example Signaling for RACH Configuration and Adaptation

FIG. 6A depicts a process flow 600 for communications in a network between a network entity 602 and a UE 604. In certain aspects, the network entity 602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. However, in other aspects, UE 604 may be another type of wireless communications device and network entity 602 may be another type of network entity or network node, such as those described herein. Note that any operations or signaling illustrated with dashed lines may indicate that that operation or signaling is an optional or alternative example.

Process flow 600 begins, at 606, with network entity 602 transmitting, to UE 604, signaling configuring UE 604 with multiple uplink (UL) BWPs. The multiple uplink BWPs configured at UE 604 may include at least a first uplink BWP (e.g., BWP1) for a first cell. Although not shown in FIG. 6A, prior to process flow 600 beginning, UE 604 may obtain signaling configuring the UE 604 with an initial uplink BWP (e.g., BWP0). For example, the initial BWP configuration may be broadcast as system information, and detected by UE 604, prior to the transmission of any UE-specific configuration (e.g., the signaling sent at 606). As used herein, an “initial uplink BWP” may refer to a subset or a part of total carrier bandwidth that UE 604 uses for initial access (e.g., performing a RACH procedure) to establish an initial RRC connection with network entity 602.

To save power, only one uplink BWP may be activated (e.g., for the first cell) for the UE at a time. Thus, at 608, UE 604 determines to activate one of the configured uplink BWPs. In this example, UE 604 selects the first uplink BWP to be the current, active uplink BWP of UE 604. As used herein, the “active uplink BWP” of UE 604 (e.g., in this example, the first uplink BWP) may refer to a specific BWP (e.g., a designated frequency band) that UE 604 is currently using for data transmission.

At 610, network entity 602 transmits, to UE 604, a legacy RACH configuration for the initial uplink BWP (e.g., configured for UE 604 at 606). The legacy RACH configuration may identify certain parameters for random access communications in the initial uplink BWP. Example parameters associated with the legacy RACH configuration may include a RACH configuration index (prach-ConfigurationIndex), a msg-1 FDM parameter (msg1-FDM), a random access response window parameter (ra-ResponseWindow), and/or the like.

In certain aspects, the legacy RACH configuration may identify one or more legacy ROs that correspond to time-frequency resource(s) configured for random access communications in the initial uplink BWP (e.g., “legacy RO(s) associated with the legacy RACH configuration”). The legacy RO(s) in the initial uplink BWP may be fixed, meaning that they remain active for random access communications in the initial uplink BWP and may not be adjusted (e.g., deactivated or re-activated) to account for varying network requirements.

As an illustrative example shown in FIG. 6B, the legacy RACH configuration may be associated with ROs 632-1 through 632-8 (individually referred to herein as “legacy RO 632” and collectively referred to herein as “legacy ROs 632”). UE 604 of FIG. 6A may use one of legacy ROs 632, shown in FIG. 6B, for sending a random access message, in the initial uplink BWP of the UE, to initiate a RACH procedure (e.g., such as RACH procedure 500a of FIG. 5A or RACH procedure 500b of FIG. 5B) with network entity 602 of FIG. 6A.

At 612, network entity 602 transmits, to UE 604, a virtual RACH configuration for the first uplink BWP (e.g., configured for UE 604 at 606). The virtual RACH configuration may identify certain parameters for random access communications in the first uplink BWP. Example parameters associated with the virtual RACH configuration may include a RACH configuration index (prach-ConfigurationIndex), a msg-1 FDM parameter (msg1-FDM), a random access response window parameter (ra-ResponseWindow), and/or the like.

In certain aspects, the virtual RACH configuration may identify one or more virtual ROs. The virtual RO(s) may appear to correspond to scheduled time-frequency resource(s) scheduled for random access communications in the first uplink BWP; however, the virtual ROs may not be used for such communications. Instead, the virtual RO(s) of the virtual RACH configuration may be configured to allow for the configuration of additional RO(s) in the first uplink BWP.

In the illustrative example shown in FIG. 6B, the virtual RACH configuration may be associated with ROs 634-1 through 634-8 (individually referred to herein as “virtual RO 634” and collectively referred to herein as “virtual ROs 634”). Virtual ROs 634 may not be associated with any time-frequency resources that are scheduled for random access communications in the first uplink BWP of the UE. Thus, the virtual ROs 634, although configured, may not represent available ROs for sending random access message(s) in the first uplink BWP.

At 614, network entity 602 transmits, to UE 604, an additional RACH configuration. The additional RACH configuration may be associated with the virtual RACH configuration transmitted to UE 604 at 612, or more specifically, may be defined relative to the virtual RACH configuration transmitted to UE 604 at 612. The additional RACH configuration may be defined “relative to” the virtual RACH configuration based on adapting one or more parameters of the legacy RACH configuration.

In certain aspects, the additional RACH configuration may identify additional RO(s) (e.g., beyond the virtual RO(s) of the virtual RACH configuration transmitted to UE 604 at 612) that correspond to time-frequency resources configured for random access communications in the first uplink BWP (e.g., “additional RO(s) associated with the additional RACH configuration”). In certain aspects, the additional RACH configuration may be transmitted to UE 604, by network entity 602 at 614, such as to accommodate varying network requirements. For example, the additional RO(s) configured by the additional RACH configuration in the first uplink BWP (and in the time domain), may be activated and/or deactivated over time, such as in response to changing network traffic and/or access requests.

As an illustrative example, the additional RACH configuration may be associated with additional ROs 636-1 through 636-16 (individually referred to herein as “additional RO 636” and collectively referred to herein as “additional ROs 636”). In certain aspects, the additional ROs 636, when initially configured, may be deactivated such that network entity 602 of FIG. 6A does not need to monitor these additional ROs 636 for random access message(s) from UE 604 of FIG. 6A (e.g., used to initiate one or more RACH procedures). However, at a later time, one or more of the additional ROs 636 may be activated and used for random access communications. For example, in certain aspects, UE 604 of FIG. 6A may receive a RACH configuration adaptation indication for the virtual RACH configuration. The RACH configuration adaptation indication may indicate the activation of the additional ROs 636. Activating the adaptation may (e.g., dynamically) adjust the RO(s) available for random access communications, such that one or more of the additional ROs 636 (e.g., in some cases all additional ROs 636 and in some cases less than all additional ROs 636) are available for use by (e.g., activated for) UE 604 of FIG. 6A for communicating a subsequent random access message

As shown in the example depicted in FIG. 6A, at 616, network entity 602 transmits, to UE 604, a RACH configuration adaptation indication. The RACH configuration adaptation indication may be associated with the additional ROs of the additional RACH configuration, configured for the first uplink BWP (and UE 604) at 614. In certain aspects, network entity 602 may transmit the RACH configuration adaptation indication to adapt the virtual RACH configuration, configured for the first uplink BWP, such that RO(s) available to UE 604 for random access communications in the first uplink BWP are increased (e.g., such as to allow for more frequency random access message transmission by the UE 604).

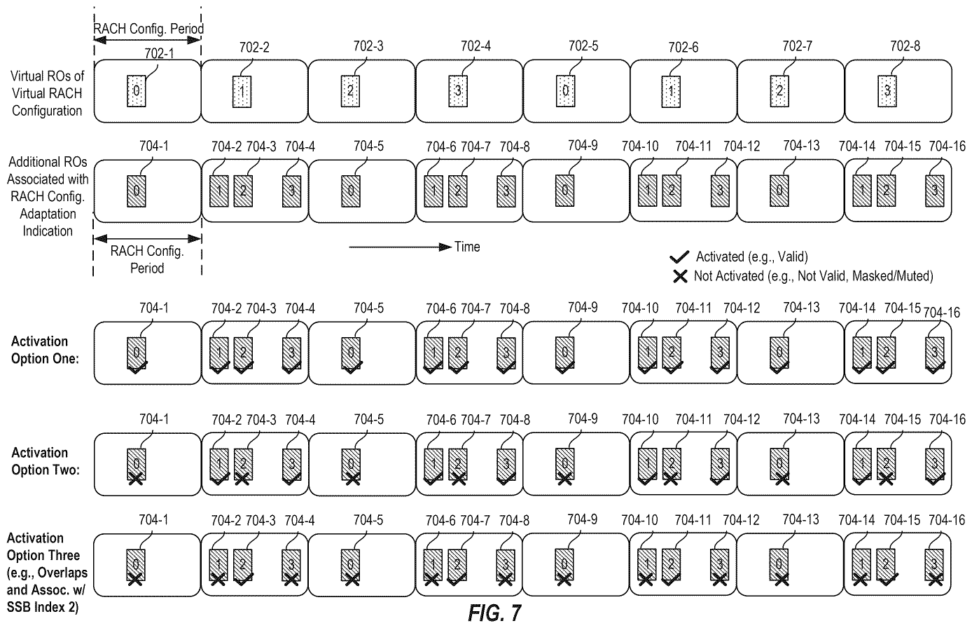

At 618, UE 604 activates one or more of the additional ROs (associated with the additional RACH configuration) configured at 614. For example, UE 604 may activate one or more of the additional ROs 636 (e.g., all or less than all of additional ROs 636) shown in FIG. 6B for random access communications in the first uplink BWP. Different options for activating the additional ROs may be considered. Example options for activating additional ROs based on receiving a RACH configuration adaptation indication are illustrated in FIG. 7.

Although not meant to be limiting to this particular example, in FIGS. 6A and 6B, UE 604 may activate all of the additional ROs 636 based on receiving the RACH configuration adaptation indication. Activation of all of the additional ROs 636 may enable UE 604 to send a random access message in at least one of the additional ROs 636 to initiate a RACH procedure in the first uplink BWP. Initiating the RACH procedure in the first uplink BWP may help to avoid additional power consumed and/or latency encountered when needing to switch BWPs for initiating a RACH procedure.

For example, as shown in FIG. 6A, as a first option, UE 604 transmits, to network entity 602 at 622, a random access message (e.g., MSG1 depicted and described above with respect to FIG. 5A) in a first additional RO that is activated at 618 by UE 604. The first additional RO may include one of the additional ROs 636 shown in FIG. 6B. The transmission of the random access message at 622 may be used to initiate a RACH procedure between UE 604 and network entity 602 in the first uplink BWP.

Alternatively, as shown in FIG. 6A, as a second option, UE 604 switches its active uplink BWP from the first uplink BWP to the initial uplink BWP (e.g., configured at UE 604 at 606). At 626, UE 604 then transmits, to network entity 602 at 626, a random access message (e.g., MSG1 depicted and described above with respect to FIG. 5A) in a first legacy RO. The first legacy RO may include one of the legacy ROs 632 shown in FIG. 6B. The transmission of the random access message at 626 may be used to initiate a RACH procedure between UE 604 and network entity 602 in the initial uplink BWP.

In certain aspects, UE 604 may autonomously determine to initiate the RACH procedure and thus transmit the random access message at 622 (e.g., in the first option) or at 626 (e.g., in the second option).

In certain other aspects, however, UE 604 may be triggered to initiate the RACH procedure and thus transmit the random access message at 622 (e.g., in the first option) or at 626 (e.g., in the second option). For example, optionally at 620, network entity 602 may transmit, to UE 604, an indication to initiate a RACH procedure. In certain aspects, the indication to initiate the RACH procedure may comprise a PDCCH order, which is a command sent by network entity 602 via a PDCCH that instructs UE 604 to initiate the RACH procedure (e.g., instructs UE 604 to try and establish a connection), such as with network entity 602. In certain aspects, the indication to initiate the RACH procedure may include the RACH configuration adaptation indication (e.g., although in FIG. 6A the RACH configuration adaptation indication is shown as separately being sent to UE 604 at 616).

In some cases, the indication to initiate the RACH procedure (e.g., optionally transmitted to UE 604 at 620) may not include any indication as to whether UE 604 should use the virtual ROs (e.g., virtual ROs 634 shown in FIG. 6B) or the additional RO(s), which have been activated (e.g., additional RO(s) 636 shown in FIG. 6B, which have been activated), to initiate the RACH procedure. For these cases, the UE 604 may utilize the first option shown in FIG. 6A. For example, the UE 604 may transmit, to network entity 602 at 622, a random access message in a first additional RO that is activated at 618 by UE 604.

In some cases, the indication to initiate the RACH procedure (e.g., optionally transmitted to UE 604 at 620) may include an indication to the additional RO(s), which have been activated (e.g., additional RO(s) 636 shown in FIG. 6B, which have been activated), to initiate the RACH procedure. For these cases, the UE 604 may utilize the first option shown in FIG. 6A. For example, the UE 604 may transmit, to network entity 602 at 622, a random access message in a first additional RO that is activated at 618 by UE 604.

In some cases, the indication to initiate the RACH procedure (e.g., optionally transmitted to UE 604 at 620) may include an indication to use the virtual ROs (e.g., virtual ROs 634 shown in FIG. 6B) to initiate the RACH procedure. For these cases, the UE 604 may utilize the first option or the second option shown in FIG. 6A. If utilizing the first option, the UE 604 may transmit, to network entity 602 at 622, a random access message in a first additional RO that is activated at 618 by UE 604. If utilizing the second option, the UE 604 may perform BWP switching, at 624 to switch an activate uplink BWP of the UE 604 to the initial uplink BWP, and transmit, to network entity 602 at 626, a random access message in a first legacy RO (e.g., configured for the initial uplink BWP.

Note that the process flow 600 illustrated in FIG. 6A is described herein to facilitate an understanding of RACH configuration adaptation utilizing a virtual RACH configuration, and aspects of the present disclosure may be performed in various manners via alternative or additional signaling and/or operations. In certain aspects, the operations and/or signaling of FIG. 6A may occur in an order different from that described or depicted, and various actions, operations, and/or signaling may be added, omitted, or combined.

FIG. 7 depicts example activation of additional ROs configured for an active uplink BWP of a UE. In FIG. 7, the active uplink BWP may be a first uplink BWP of a UE where no legacy ROs are configured. Instead, the active, first uplink BWP may be configured with virtual ROs associated with a virtual RACH configuration.

For example, as shown, an example virtual RACH configuration may configure a UE with virtual ROs 702-1 through 702-8 (individually referred to herein as “virtual RO 702” and collectively referred to herein as “virtual ROs 702”) in the first uplink BWP. The virtual ROs 702 of the virtual RACH configuration may be configured to allow for the configuration of additional ROs 704 in the first uplink BWP. For example, as further shown, an example additional RACH configuration may configure the UE with additional ROs 704-1 through 704-16 (individually referred to herein as “additional RO 704” and collectively referred to herein as “additional ROs 704”) in the first uplink BWP. The additional RACH configuration may be defined “relative to” the virtual RACH configuration based on adapting one or more parameters of the legacy RACH configuration.

In certain aspects, the additional ROs 704, when initially configured, may be deactivated. However, at a later time, one or more of the additional ROs 704 may be activated and used for random access communications. For example, in certain aspects, one or more of the additional ROs 704 may be activated based on a RACH configuration adaptation indication associated with additional ROs 704 (e.g., which may be transmitted from a network entity to a UE, such as the RACH configuration adaptation indication transmitted from network entity 602 to UE 604 at 616 in FIG. 6A). Different options for activating additional ROs based on a RACH configuration adaptation indication are shown in FIG. 7.

For example, in a first option, the additional ROs 704 (e.g., of the additional RACH configuration) that are activated based on the RACH configuration adaptation indication may include all of the additional ROs 704. In particular, all additional ROs 704 may be activated for random access communications in the first uplink BWP irrespective of whether or not each additional RO 704 overlaps (at least partially) a virtual RO 702. Additional ROs 704 that are activated may be considered “valid” for initiating a RACH procedure in the first uplink BWP.

In a second option, the additional ROs 704 (e.g., of the additional RACH configuration) that are activated based on the RACH configuration adaptation indication may include only the additional ROs 704 that do not overlap any of the virtual ROs 702. For example, as shown, because additional RO 704-1 overlaps virtual RO 702-1 in the time domain, additional RO 704-1 may not be activated. On the other hand, because additional RO 704-2 does not overlap any of the virtual ROs 702, then additional RO 704-2 may be activated. Additional ROs 704 that are activated may be considered “valid” for initiating a RACH procedure in the first uplink BWP. Additionally, additional ROs 704 that are not activated may be considered “invalid,” “masked,” or “muted” for initiating a RACH procedure in the first uplink BWP.

In a third option, the additional ROs 704 (e.g., of the additional RACH configuration) that are activated based on the RACH configuration adaptation indication may include only a subset of the additional ROs 704. Each additional RO 704 included in the subset of the additional ROs 704, which are activated, may (1) overlap, in the time domain, with a virtual RO 702, and (2) be associated with a particular SSB index. For example, as shown in FIG. 7, the additional ROs that are activated may include additional ROs 704 that overlap a subset of the virtual ROs 702 and are associated with SSB index 2. For example, additional RO 704-3 may be activated because (1) additional RO 704-3 overlaps virtual RO 702-2 in the time domain and (2) additional RO 704-3 is associated with SSB index 2.

As used herein, an “SSB index” is a unique numerical identifier that may be assigned to a specific SSB transmitted to the UE by a network entity. Specifically, different sets of ROs (e.g., one or more ROs of the virtual ROs 702 and the additional ROs 704) may be mapped to different SSB indexes. For example, as shown in FIG. 7, virtual ROs 702-1 and 702-5, as well as additional ROs 704-1, 704-5, 704-9, and 704-13, may be mapped to SSB index 0, such that these six ROs are associated with communicating random access communications (e.g., a preamble of the RACH procedure) associated with transmission(s), to the UE, of SSB(s) associated with SSB index 0. Specifically, a UE may receive an SSB associated with SSB index 0, measure the SSB to determine a preferred beam to use for communication, and then send, in one of these ROs, a preamble indicating the preferred beam. It is noted, however, that the virtual ROs 702-1 and 702-5 may only appear to be used for such random access communications, while 704-1, 704-5, 704-9, and 704-13 may be used for such random access communications only when activated.

In another option not shown in FIG. 7, the additional ROs 704 (e.g., of the additional RACH configuration) that are activated based on the RACH configuration adaptation indication may include only a subset of the additional ROs 704. Each additional RO 704 included in the subset of the additional ROs 704, which is activated, may overlap, in the time domain, with one of the virtual ROs 702 that has a specific SSB index. For example, an additional RO 704 may be activated because (1) the additional RO 704 overlaps one of the virtual ROs 702 in the time domain and (2) this specific virtual RO 702 is associated with a specific SSB index.

In another option not shown in FIG. 7, the additional ROs 704 (e.g., of the additional RACH configuration) that are activated based on the RACH configuration adaptation indication may include only a subset of the additional ROs 704. Each additional RO 704 included in the subset of the additional ROs 704, which is activated, may (1) overlap, in the time domain, with a virtual RO 702, and (2) involve a specific type of overlap. Example overlap types that may be considered include a full overlap of the virtual RO 702, a partial overlap of the virtual RO 702 without fully overlapping the virtual RO 702, and/or the like. The overlap may occur in time and/or in frequency, and/or may comprise a partial overlap or a full overlap.

In certain aspects, a UE may be configured to follow one of the aforementioned options for activating additional ROs 704 based on receiving a RACH configuration adaptation indication. In certain aspects, the UE may be configured to follow one of the aforementioned options via RRC signaling. Alternatively, in certain aspects, a default behavior for activating additional ROs may not be indicated to the UE.

In certain aspects, a virtual RACH configuration and an additional RACH configuration may each be associated with one or more association periods. As used herein, an “association period” of a RACH configuration may refer to a time period of the smallest integer of {1, 2, 4, 8, 16} RACH configuration periods that include ROs associated with at least one instance of every SSB index. A “RACH configuration period” may refer to a time interval for which ROs are available for use by one or more UEs to access the network. Further, a RACH configuration period may comprise a configuration parameter of a RACH configuration, which defines the periodicity of the RACH resources based on the RACH configuration, regardless of whether they are valid or not.

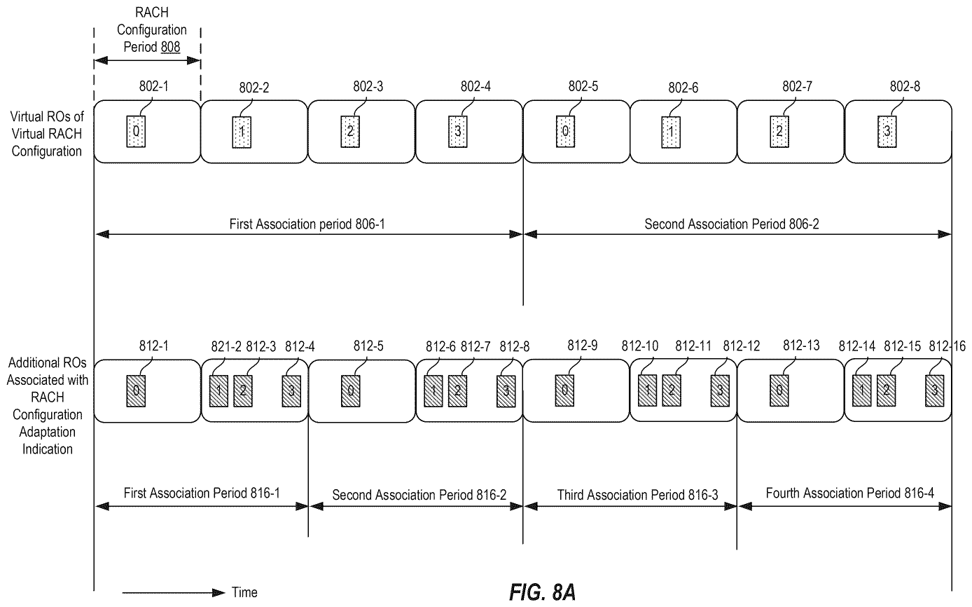

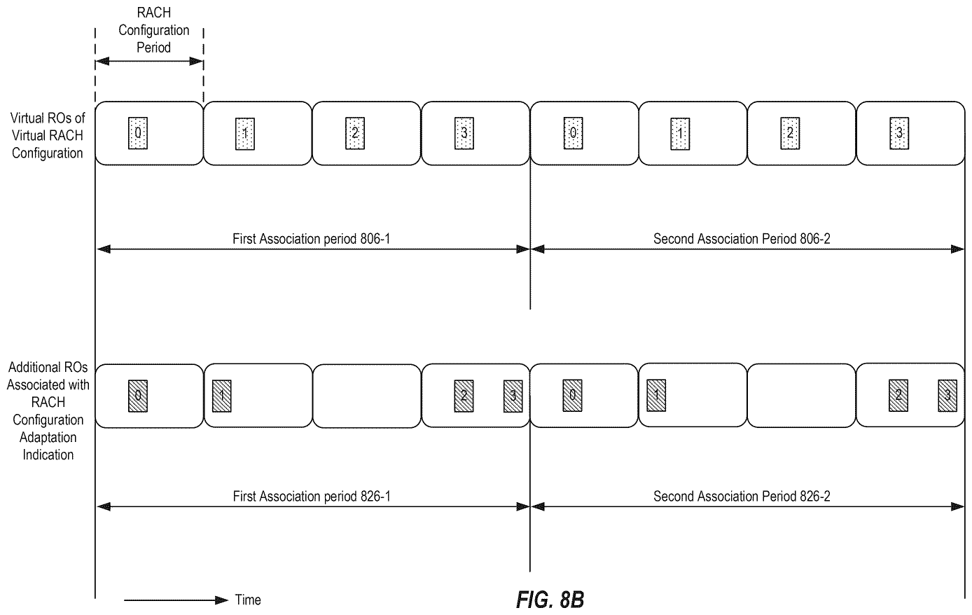

In certain aspects, association periods associated with a virtual RACH configuration may be different than association periods associated with an additional RACH configuration, which are both associated with a same uplink BWP. This scenario is illustrated in FIG. 8A.

For example, as shown in FIG. 8A, an example virtual RACH configuration may configure a UE (not shown) with virtual ROs 802-1 through 802-8 (individually referred to herein as “virtual RO 802” and collectively referred to herein as “virtual ROs 802”) in a first uplink BWP of the UE. Further, an example additional RACH configuration may configure the UE with additional ROs 812-1 through 812-16 (individually referred to herein as “additional RO 812” and collectively referred to herein as “additional ROs 816”) in the first uplink BWP of the UE.

A first association period 806-1 of the virtual RACH configuration may include virtual ROs 802-1 through 802-4 (e.g., associated with SSB indexes 0-3) in four RACH configuration periods 808. A second association period 806-2 of the virtual RACH configuration may include virtual ROs 802-5 through 802-8 (e.g., associated with SSB indexes 0-3) also in four RACH configuration periods 808.

A first association period 816-1 of the additional RACH configuration may include additional ROs 812-1 through 812-4 (e.g., associated with SSB indexes 0-3) in two RACH configuration periods 808. A second association period 816-2 of the additional RACH configuration may include additional ROs 812-5 through 812-8 (e.g., associated with SSB indexes 0-3) also in two RACH configuration periods 808. This same pattern may repeat for third association period 816-3 and fourth association period 816-4 of the additional RACH configuration.

Thus, as shown in FIG. 8A, the first association period 806-1 and the second association period 806-2 of the virtual RACH configuration may be different (e.g., associated with longer time periods) than the first association period 816-1, second association period 816-2, third association period 816-3, and fourth association period 816-4 associated with the additional RACH configuration.

Alternatively, in certain aspects, a virtual RACH configuration and an additional RACH configuration (e.g., defined relative to the virtual RACH configuration) may be associated with the same association periods. This scenario is illustrated in FIG. 8B. For example, as shown in FIG. 8B, first association period 806-1 and second association period 806-2 associated with a virtual RACH configuration may align in time with a first association period 826-1 and a second association period 826-2 associated with an additional RACH configuration.

### Example Operations of a User Equipment

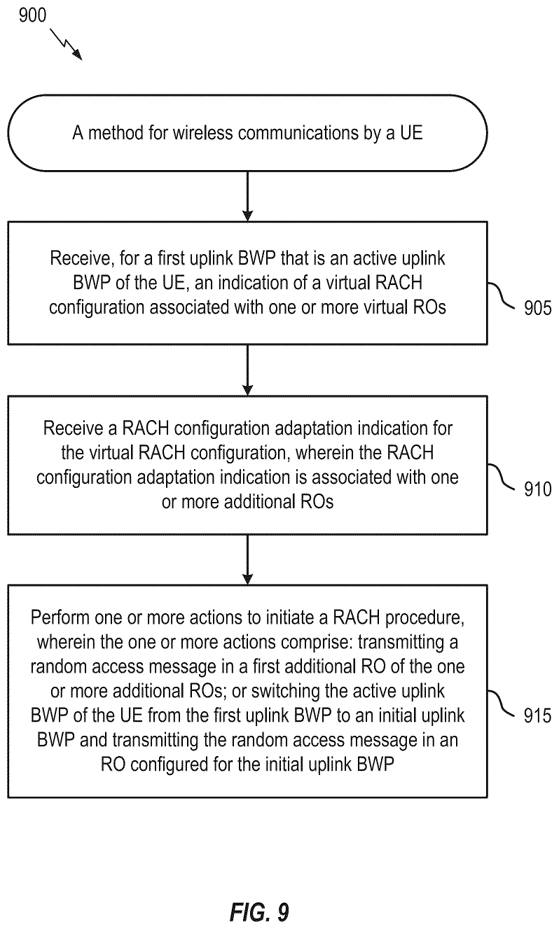

FIG. 9 shows a method 900 for wireless communications by an apparatus, such as UE 104 of FIG. 1 or UE 304 of FIG. 3.

Method 900 begins at block 905 with receiving, for a first uplink BWP that is an active uplink BWP of the UE, an indication of a virtual RACH configuration associated with one or more virtual ROs. Example reception of an indication of a virtual RACH configuration that is associated with one or more virtual ROs is depicted and described above with respect to step 612 of FIG. 6A.

Method 900 then proceeds to block 910 with receiving a RACH configuration adaptation indication for the virtual RACH configuration, wherein the RACH configuration adaptation indication is associated with one or more additional ROs. Example reception of a RACH configuration adaptation indication is depicted and described above with respect to step 616 of FIG. 6A.

Method 900 then proceeds to block 915 with performing one or more actions to initiate a RACH procedure, wherein the one or more actions comprise: transmitting a random access message in a first additional RO of the one or more additional ROs; or switching the active uplink BWP of the UE from the first uplink BWP to an initial uplink BWP and transmitting the random access message in an RO configured for the initial uplink BWP. Example transmission of a random access message in a first additional RO is depicted and described above with respect to step 622 of FIG. 6A. Example BWP switching and transmission of a random access message in an RO configured for an initial uplink BWP is depicted and described above with respect to steps 624 and 626 of FIG. 6A.

In some aspects, method 900 further includes receiving an indication to initiate the RACH procedure.

In some aspects, method 900 further includes performing the one or more actions based on the indication.

In some aspects, the indication to initiate the RACH procedure excludes any indication to use the one or more virtual ROs or the one or more additional ROs to initiate the RACH procedure; and the one or more actions comprise transmitting the random access message in the first additional RO of the one or more additional ROs.

In some aspects, the indication to initiate the RACH procedure comprises an indication to use the one or more additional ROs to initiate the RACH procedure; and the one or more actions comprise transmitting the random access message in the first additional RO of the one or more additional ROs.

In some aspects, the indication to initiate the RACH procedure comprises an indication to use the one or more virtual ROs to initiate the RACH procedure; and the one or more actions comprise transmitting the random access message in the first additional RO of the one or more additional ROs.

In some aspects, the indication to initiate the RACH procedure comprises an indication to use the one or more virtual ROs to initiate the RACH procedure; and the one or more actions comprise: switching the active uplink BWP of the UE from the first uplink BWP to the initial uplink BWP; and transmitting the random access message in the RO configured for the initial uplink BWP.

In some aspects, method 900 further includes receiving, for the initial uplink BWP, an indication of a legacy RACH configuration associated with one or more legacy ROs comprising at least the RO.

In some aspects, method 900 further includes adapting the virtual RACH configuration to activate at least the first additional RO of the one or more additional ROs based on the RACH configuration adaptation indication.

In some aspects, the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the first subset of the plurality of additional ROs or the second subset of the plurality of additional ROs comprises the first additional RO; and adapting the virtual RACH configuration comprises activating the first subset of the plurality of additional ROs and the second subset of the plurality of additional ROs.

In some aspects, the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the second subset of the plurality of additional ROs comprises the first additional RO; and adapting the virtual RACH configuration comprises activating the second subset of the plurality of additional ROs and not activating the first subset of the plurality of additional ROs.

In some aspects, the one or more virtual ROs comprise a plurality of virtual ROs; the one or more additional ROs comprise a plurality of additional ROs; each additional RO of a first subset of the plurality of additional ROs overlaps, in a time domain and according to a first overlap type, a first subset of the plurality of virtual ROs; each additional RO of a second subset of the plurality of additional ROs overlaps, in the time domain and according to a second overlap type, a second subset of the plurality of virtual ROs; the first subset of the plurality of additional ROs comprises the first additional RO; and adapting the virtual RACH configuration comprises activating the first subset of the plurality of additional ROs and not activating the second subset of the plurality of additional ROs.

In some aspects, the first additional RO overlaps, in a time domain, a first virtual RO of the one or more virtual ROs; and the first virtual RO is associated with a first SSB index.

In some aspects, method 900 further includes receiving signaling that configures the UE to activate at least the first additional RO based on one or more conditions.

In some aspects, the one or more additional ROs are associated with one or more first association periods that are different than one or more second association periods associated with the one or more virtual ROs.

In some aspects, the one or more additional ROs and the one or more virtual ROs are both associated with one or more association periods.

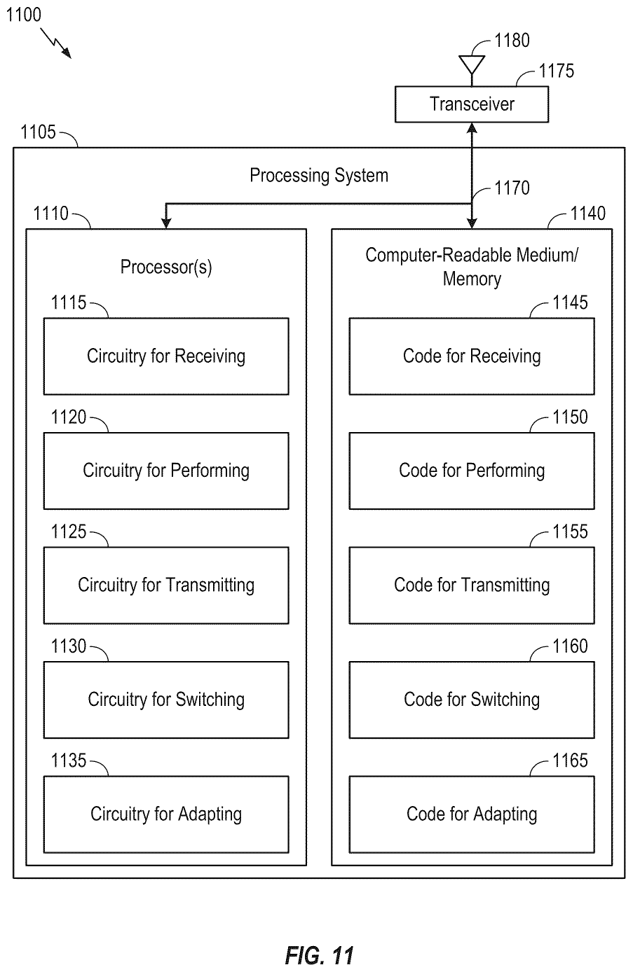

In some aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Operations of a Network Entity

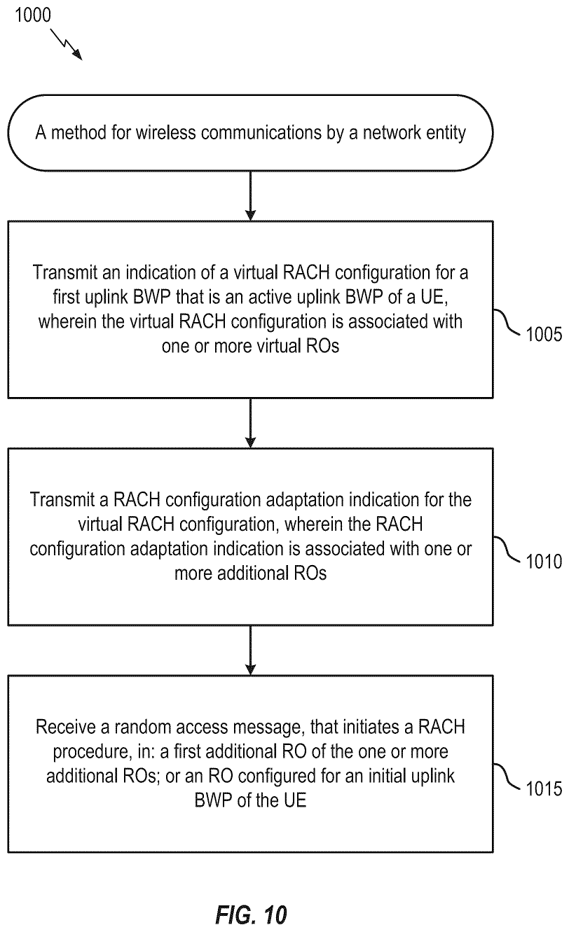

FIG. 10 shows a method 1000 for wireless communications by an apparatus, such as BS 102 of FIG. 1, a first network entity 300 or second network entity 302 of FIG. 3, or a disaggregated base station as discussed with respect to FIG. 2.

Method 1000 begins at block 1005 with transmitting an indication of a virtual RACH configuration for a first uplink BWP that is an active uplink BWP of a UE, wherein the virtual RACH configuration is associated with one or more virtual ROs. Example transmission of an indication of a virtual RACH configuration that is associated with one or more virtual ROs is depicted and described above with respect to step 612 of FIG. 6A.

Method 1000 then proceeds to block 1010 with transmitting a RACH configuration adaptation indication for the virtual RACH configuration, wherein the RACH configuration adaptation indication is associated with one or more additional ROs. Example transmission of a RACH configuration adaptation indication is depicted and described above with respect to step 616 of FIG. 6A.

Method 1000 then proceeds to block 1015 with receiving a random access message, that initiates a RACH procedure, in: a first additional RO of the one or more additional ROs; or an RO configured for an initial uplink BWP of the UE. Example reception of a random access message in a first additional RO is depicted and described above with respect to step 622 of FIG. 6A. Example reception of a random access message in an RO configured for an initial uplink BWP is depicted and described above with respect to step 626 of FIG. 6A.

In certain aspects, method 1000 further includes transmitting an indication to initiate the RACH procedure.

In certain aspects, method 1000 further includes receiving the random access message based on the indication.

In some aspects, the indication to initiate the RACH procedure excludes any indication to use the one or more virtual ROs or the one or more additional ROs to initiate the RACH procedure; and block 1015 includes receiving the random access message in the first additional RO of the one or more additional ROs.

In some aspects, the indication to initiate the RACH procedure comprises an indication to use the one or more additional ROs to initiate the RACH procedure; and block 1015 includes receiving the random access message in the first additional RO of the one or more additional ROs.

In some aspects, the indication to initiate the RACH procedure comprises an indication to use the one or more virtual ROs to initiate the RACH procedure; and block 1015 includes receiving the random access message in the first additional RO of the one or more additional ROs.

In some aspects, the indication to initiate the RACH procedure comprises an indication to use the one or more virtual ROs to initiate the RACH procedure; and block 1015 includes receiving the random access message in the RO configured for the initial uplink BWP of the UE.

In certain aspects, method 1000 further includes transmitting, for the initial uplink BWP, an indication of a legacy RACH configuration associated with one or more legacy ROs comprising at least the RO.

In certain aspects, method 1000 further includes adapting the virtual RACH configuration to activate at least the first additional RO of the one or more additional ROs based on the RACH configuration adaptation indication.

In some aspects, the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the first subset of the plurality of additional ROs or the second subset of the plurality of additional ROs comprises the first additional RO; and adapting the virtual RACH configuration comprises activating the first subset of the plurality of additional ROs and the second subset of the plurality of additional ROs.

In some aspects, the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the second subset of the plurality of additional ROs comprises the first additional RO; and adapting the virtual RACH configuration comprises activating the second subset of the plurality of additional ROs and not activating the first subset of the plurality of additional ROs.

In some aspects, the one or more virtual ROs comprise a plurality of virtual ROs; the one or more additional ROs comprise a plurality of additional ROs; each additional RO of a first subset of the plurality of additional ROs overlaps, in a time domain and according to a first overlap type, a first subset of the plurality of virtual ROs; each additional RO of a second subset of the plurality of additional ROs overlaps, in the time domain and according to a second overlap type, a second subset of the plurality of virtual ROs; the first subset of the plurality of additional ROs comprises the first additional RO; and adapting the virtual RACH configuration comprises activating the first subset of the plurality of additional ROs and not activating the second subset of the plurality of additional ROs.

In some aspects, the first additional RO overlaps, in a time domain, a first virtual RO of the one or more virtual ROs; and the first virtual RO is associated with a first SSB index.

In certain aspects, method 1000 further includes transmitting signaling that configures the UE to activate at least the first additional RO based on one or more conditions.

In some aspects, the one or more additional ROs are associated with one or more first association periods that are different than one or more second association periods associated with the one or more virtual ROs.

In some aspects, the one or more additional ROs and the one or more virtual ROs are both associated with one or more association periods.

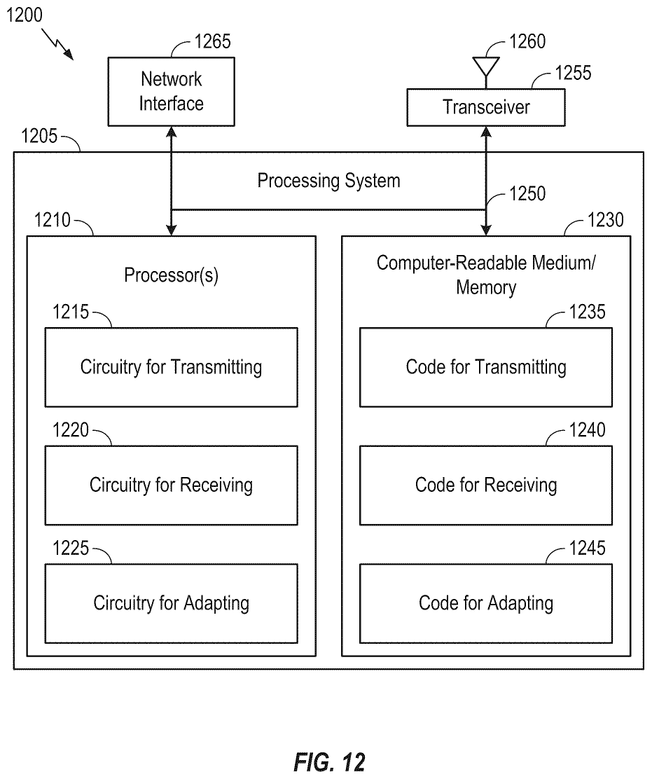

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100 configured for wireless communications. In some aspects, communications device 1100 is a user equipment, such as UE 104 described above with respect to FIG. 1 or UE 304 described with respect to FIG. 3.

The communications device 1100 includes a processing system 1105 coupled to a transceiver 1175 (e.g., a transmitter and/or a receiver). The transceiver 1175 is configured to transmit and receive signals for the communications device 1100 via an antenna 1180, such as the various signals as described herein. The processing system 1105 may be configured to perform processing functions for the communications device 1100, including processing signals received and/or to be transmitted by the communications device 1100.

The processing system 1105 includes one or more processors 1110 and a computer-readable medium/memory 1140. In various aspects, the one or more processors 1110 may be representative of the one or more processors 318 described with respect to FIG. 3. The one or more processors 1110 are coupled to a computer-readable medium/memory 1140 via a bus 1170. In some aspects, the computer-readable medium/memory 1140 may be representative of the one or more memories 320 described with respect to FIG. 3. The computer-readable medium/memory 1140 is a non-transitory computer-readable medium/memory. In certain aspects, the computer-readable medium/memory 1140 is configured to store instructions (e.g., computer-executable code), that when executed by the one or more processors 1110, cause the one or more processors 1110 to perform the method 900 described with respect to FIG. 9, or any aspect related to it, including any operations described in relation to FIG. 9. Note that reference to a processor performing a function of communications device 1100 may include one or more processors performing that function of communications device 1100, such as in a distributed fashion.

In the depicted example, computer-readable medium/memory 1140 stores code (e.g., executable instructions), including code for receiving 1145, code for performing 1150, code for transmitting 1155, code for switching 1160, and code for adapting 1165. Processing of the code 1145-1165 may enable and cause the communications device 1100 to perform the method 900 described with respect to FIG. 9, or any aspect related to it. For instance, in some aspects, code for receiving 1145 includes code for receiving, for a first uplink BWP that is an active uplink BWP of the UE, an indication of a virtual RACH configuration associated with one or more virtual ROs. In some aspects, code for receiving 1145 includes code for receiving a RACH configuration adaptation indication for the virtual RACH configuration, wherein the RACH configuration adaptation indication is associated with one or more additional ROs. In some aspects, code for performing 1150 includes code for performing one or more actions to initiate a RACH procedure, wherein the one or more actions comprise: transmitting a random access message in a first additional RO of the one or more additional ROs; or switching the active uplink BWP of the UE from the first uplink BWP to an initial uplink BWP and transmitting the random access message in an RO configured for the initial uplink BWP.

The one or more processors 1110 include circuitry configured to implement (e.g., execute) the code stored in the computer-readable medium/memory 1140, including circuitry for receiving 1115, circuitry for performing 1120, circuitry for transmitting 1125, circuitry for switching 1130, and circuitry for adapting 1135. Processing with circuitry 1115-1135 may enable and cause the communications device 1100 to perform the method 900 described with respect to FIG. 9, or any aspect related to it. For instance, in some aspects, circuitry for receiving 1115 includes circuitry for receiving, for a first uplink BWP that is an active uplink BWP of the UE, an indication of a virtual RACH configuration associated with one or more virtual ROs. In some aspects, circuitry for receiving 1115 includes circuitry for receiving a RACH configuration adaptation indication for the virtual RACH configuration, wherein the RACH configuration adaptation indication is associated with one or more additional ROs. In some aspects, circuitry for performing 1120 includes circuitry for performing one or more actions to initiate a RACH procedure, wherein the one or more actions comprise: transmitting a random access message in a first additional RO of the one or more additional ROs; or switching the active uplink BWP of the UE from the first uplink BWP to an initial uplink BWP and transmitting the random access message in an RO configured for the initial uplink BWP.

More generally, means for communicating, transmitting, sending or outputting for transmission may include the one or more transceivers 324, one or more antenna 322 and/or processing system 316 of the UE 304 illustrated in FIG. 3, transceiver 1175 and/or antenna 1180 of the communications device 1100 in FIG. 11, and/or one or more processors 1110 of the communications device 1100 in FIG. 11. Means for communicating, receiving or obtaining may include the one or more transceivers 324, one or more antennas 322, and/or processing system 316 of the UE 304 illustrated in FIG. 3, transceiver 1175 and/or antenna 1180 of the communications device 1100 in FIG. 11, and/or one or more processors 1110 of the communications device 1100 in FIG. 11.

FIG. 12 depicts aspects of an example communications device configured for wireless communications. In some aspects, communications device 1200 is a network entity, such as BS 102 of FIG. 1, first network entity 300 or second network entity 302 of FIG. 3, or a disaggregated base station as discussed with respect to FIG. 2.

The communications device 1200 includes a processing system 1205 coupled to a transceiver 1255 (e.g., a transmitter and/or a receiver) and/or a network interface 1265. The transceiver 1255 is configured to transmit and receive signals for the communications device 1200 via an antenna 1260, such as the various signals as described herein. The network interface 1265 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210 and a computer-readable medium/memory 1230. In various aspects, one or more processors 1210 may be representative of the one or more processors 308, as described with respect to FIG. 3. The one or more processors 1210 are coupled to the computer-readable medium/memory 1230 via a bus 1250. In certain aspects, the computer-readable medium/memory 1230 is configured to store instructions (e.g., computer-executable code), including code 1235-1245, that when executed by the one or more processors 1210, cause the one or more processors 1210 to perform the method 1000 described with respect to FIG. 10, or any aspect related to it, including any operations described in relation to FIG. 10. The computer-readable medium/memory 1230 is a non-transitory computer-readable medium/memory. Note that reference to a processor of communications device 1200 performing a function may include one or more processors of communications device 1200 performing that function, such as in a distributed fashion.

In the depicted example, the computer-readable medium/memory 1230 stores code (e.g., executable instructions), including code for transmitting 1235, code for receiving 1240, and code for adapting 1245. Processing of the code 1235-1245 may enable and cause the communications device 1200 to perform the method 1000 described with respect to FIG. 10, or any aspect related to it. For instance, in some aspects, code for transmitting 1235 includes code for transmitting an indication of a virtual RACH configuration for a first uplink BWP that is an active uplink BWP of a UE, wherein the virtual RACH configuration is associated with one or more virtual ROs. In some aspects, code for transmitting 1235 includes code for transmitting a RACH configuration adaptation indication for the virtual RACH configuration, wherein the RACH configuration adaptation indication is associated with one or more additional ROs. In some aspects, code for receiving 1240 includes code for receiving a random access message, that initiates a RACH procedure, in: a first additional RO of the one or more additional ROs; or an RO configured for an initial uplink BWP of the UE.

The one or more processors 1210 include circuitry configured to implement (e.g., execute) the code stored in the computer-readable medium/memory 1230, including circuitry for transmitting 1215, circuitry for receiving 1220, and circuitry for adapting 1225. Processing with circuitry 1215-1225 may enable and cause the communications device 1200 to perform the method 1000 described with respect to FIG. 10, or any aspect related to it. For instance, in some aspects, circuitry for transmitting 1215 includes circuitry for transmitting an indication of a virtual RACH configuration for a first uplink BWP that is an active uplink BWP of a UE, wherein the virtual RACH configuration is associated with one or more virtual ROs. In some aspects, circuitry for transmitting 1215 includes circuitry for transmitting a RACH configuration adaptation indication for the virtual RACH configuration, wherein the RACH configuration adaptation indication is associated with one or more additional ROs. In some aspects, circuitry for receiving 1220 includes circuitry for receiving a random access message, that initiates a RACH procedure, in: a first additional RO of the one or more additional ROs; or an RO configured for an initial uplink BWP of the UE.

Various components of the communications device 1200 may provide means for performing the method 1000 described with respect to FIG. 10, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1255, antenna 1260, and/or network interface 1265 of the communications device 1200 in FIG. 12, and/or one or more processors 1210 of the communications device 1200 in FIG. 12. Means for communicating, receiving or obtaining may include the one or more transceivers 312, one or more antennas 314, and/or processing system 306 of the first network entity 300 or the second network entity 302 illustrated in FIG. 3, transceiver 1255, antenna 1260, and/or network interface 1265 of the communications device 1200 in FIG. 12, and/or one or more processors 1210 of the communications device 1200 in FIG. 12.

### EXAMPLE CLAUSES

Implementation examples are described in the following numbered clauses:

Clause 1: A method for wireless communications by a UE comprising: receiving, for a first uplink BWP that is an active uplink BWP of the UE, an indication of a virtual RACH configuration associated with one or more virtual ROs; receiving a RACH configuration adaptation indication for the virtual RACH configuration, wherein the RACH configuration adaptation indication is associated with one or more additional ROs; and performing one or more actions to initiate a RACH procedure, wherein the one or more actions comprise: transmitting a random access message in a first additional RO of the one or more additional ROs; switching the active uplink BWP of the UE from the first uplink BWP to an initial uplink BWP and transmitting the random access message in an RO configured for the initial uplink BWP.

Clause 2: The method of Clause 1, further comprising receiving an indication to initiate the RACH procedure; and performing the one or more actions based on the indication.

Clause 3: The method of Clause 2, wherein: the indication to initiate the RACH procedure excludes any indication to use the one or more virtual ROs or the one or more additional ROs to initiate the RACH procedure; and the one or more actions comprise transmitting the random access message in the first additional RO of the one or more additional ROs.

Clause 4: The method of Clause 2, wherein: the indication to initiate the RACH procedure comprises an indication to use the one or more additional ROs to initiate the RACH procedure; and the one or more actions comprise transmitting the random access message in the first additional RO of the one or more additional ROs.

Clause 5: The method of Clause 2, wherein: the indication to initiate the RACH procedure comprises an indication to use the one or more virtual ROs to initiate the RACH procedure; and the one or more actions comprise transmitting the random access message in the first additional RO of the one or more additional ROs.

Clause 6: The method of Clause 2, wherein: the indication to initiate the RACH procedure comprises an indication to use the one or more virtual ROs to initiate the RACH procedure; and the one or more actions comprise: switching the active uplink BWP of the UE from the first uplink BWP to the initial uplink BWP; and transmitting the random access message in the RO configured for the initial uplink BWP.

Clause 7: The method of Clause 6, further comprising: receiving, for the initial uplink BWP, an indication of a legacy RACH configuration associated with one or more legacy ROs comprising at least the RO.

Clause 8: The method of any one of Clauses 1-7, further comprising: adapting the virtual RACH configuration to activate at least the first additional RO of the one or more additional ROs based on the RACH configuration adaptation indication.

Clause 9: The method of Clause 8, wherein: the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the first subset of the plurality of additional ROs or the second subset of the plurality of additional ROs comprises the first additional RO; and adapting the virtual RACH configuration comprises activating the first subset of the plurality of additional ROs and the second subset of the plurality of additional ROs.

Clause 10: The method of Clause 8, wherein: the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the second subset of the plurality of additional ROs comprises the first additional RO; and adapting the virtual RACH configuration comprises activating the second subset of the plurality of additional ROs and not activating the first subset of the plurality of additional ROs.

Clause 11: The method of Clause 8, wherein: the one or more virtual ROs comprise a plurality of virtual ROs; the one or more additional ROs comprise a plurality of additional ROs; each additional RO of a first subset of the plurality of additional ROs overlaps, in a time domain and according to a first overlap type, a first subset of the plurality of virtual ROs; each additional RO of a second subset of the plurality of additional ROs overlaps, in the time domain and according to a second overlap type, a second subset of the plurality of virtual ROs; the first subset of the plurality of additional ROs comprises the first additional RO; and adapting the virtual RACH configuration comprises activating the first subset of the plurality of additional ROs and not activating the second subset of the plurality of additional ROs.

Clause 12: The method of Clause 8, wherein: the first additional RO overlaps, in a time domain, a first virtual RO of the one or more virtual ROs; and the first virtual RO is associated with a first SSB index.

Clause 13: The method of Clause 8, further comprising: receiving signaling that configures the UE to activate at least the first additional RO based on one or more conditions.

Clause 14: The method of any one of Clauses 1-13, wherein the one or more additional ROs are associated with one or more first association periods that are different than one or more second association periods associated with the one or more virtual ROs.

Clause 15: The method of any one of Clauses 1-14, wherein the one or more additional ROs and the one or more virtual ROs are both associated with one or more association periods.

Clause 16: A method for wireless communications by a network entity comprising: transmitting an indication of a virtual RACH configuration for a first uplink BWP that is an active uplink BWP of a UE, wherein the virtual RACH configuration is associated with one or more virtual ROs; transmitting a RACH configuration adaptation indication for the virtual RACH configuration, wherein the RACH configuration adaptation indication is associated with one or more additional ROs; and receiving a random access message, that initiates a RACH procedure, in: a first additional RO of the one or more additional ROs; or an RO configured for an initial uplink BWP of the UE.

Clause 17: The method of Clause 16, further comprising transmitting an indication to initiate the RACH procedure; and receiving the random access message based on the indication.

Clause 18: The method of Clause 17, wherein: the indication to initiate the RACH procedure excludes any indication to use the one or more virtual ROs or the one or more additional ROs to initiate the RACH procedure; and receiving the random access message comprises receiving the random access message in the first additional RO of the one or more additional ROs.

Clause 19: The method of Clause 17, wherein: the indication to initiate the RACH procedure comprises an indication to use the one or more additional ROs to initiate the RACH procedure; and receiving the random access message comprises receiving the random access message in the first additional RO of the one or more additional ROs.

Clause 20: The method of Clause 17, wherein: the indication to initiate the RACH procedure comprises an indication to use the one or more virtual ROs to initiate the RACH procedure; and receiving the random access message comprises receiving the random access message in the first additional RO of the one or more additional ROs.

Clause 21: The method of Clause 17, wherein: the indication to initiate the RACH procedure comprises an indication to use the one or more virtual ROs to initiate the RACH procedure; and receiving the random access message comprises receiving the random access message in the RO configured for the initial uplink BWP of the UE.

Clause 22: The method of Clause 21, further comprising: transmitting, for the initial uplink BWP, an indication of a legacy RACH configuration associated with one or more legacy ROs comprising at least the RO.

Clause 23: The method of any one of Clauses 16-22, further comprising: adapting the virtual RACH configuration to activate at least the first additional RO of the one or more additional ROs based on the RACH configuration adaptation indication.

Clause 24: The method of Clause 23, wherein: the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the first subset of the plurality of additional ROs or the second subset of the plurality of additional ROs comprises the first additional RO; and adapting the virtual RACH configuration comprises activating the first subset of the plurality of additional ROs and the second subset of the plurality of additional ROs.

Clause 25: The method of Clause 23, wherein: the one or more virtual ROs comprise a plurality of virtual ROs; the one or more additional ROs comprise a plurality of additional ROs; each additional RO of a first subset of the plurality of additional ROs at least partially overlaps, in a time domain, with the plurality of virtual ROs; a second subset of the plurality of additional ROs does not overlap, in the time domain, with the plurality of virtual ROs; the second subset of the plurality of additional ROs comprises the first additional RO; and adapting the virtual RACH configuration comprises activating the second subset of the plurality of additional ROs and not activating the first subset of the plurality of additional ROs.

Clause 26: The method of Clause 23, wherein: the one or more virtual ROs comprise a plurality of virtual ROs; the one or more additional ROs comprise a plurality of additional ROs; each additional RO of a first subset of the plurality of additional ROs overlaps, in a time domain and according to a first overlap type, a first subset of the plurality of virtual ROs; each additional RO of a second subset of the plurality of additional ROs overlaps, in the time domain and according to a second overlap type, a second subset of the plurality of virtual ROs; the first subset of the plurality of additional ROs comprises the first additional RO; and adapting the virtual RACH configuration comprises activating the first subset of the plurality of additional ROs and not activating the second subset of the plurality of additional ROs.

Clause 27: The method of Clause 23, wherein: the first additional RO overlaps, in a time domain, a first virtual RO of the one or more virtual ROs; and the first virtual RO is associated with a first SSB index.

Clause 28: The method of Clause 23, further comprising: transmitting signaling that configures the UE to activate at least the first additional RO based on one or more conditions.

Clause 29: The method of any one of Clauses 16-28, wherein the one or more additional ROs are associated with one or more first association periods that are different than one or more second association periods associated with the one or more virtual ROs.

Clause 30: The method of any one of Clauses 16-29, wherein the one or more additional ROs and the one or more virtual ROs are both associated with one or more association periods.

Clause 31: One or more apparatuses, comprising: one or more memories comprising executable instructions; and one or more processors configured to execute the executable instructions and cause the one or more apparatuses to perform a method in accordance with any one of Clauses 1-30.

Clause 32: One or more apparatuses configured for wireless communications, comprising: one or more memories; and one or more processors, coupled to the one or more memories, configured to cause the one or more apparatuses to perform a method in accordance with any one of Clauses 1-30.

Clause 33: One or more apparatuses configured for wireless communications, comprising: one or more memories; and one or more processors, coupled to the one or more memories, configured to perform a method in accordance with any one of Clauses 1-30.

Clause 34: One or more apparatuses, comprising means for performing a method in accordance with any one of Clauses 1-30.

Clause 35: One or more non-transitory computer-readable media comprising executable instructions that, when executed by one or more processors of one or more apparatuses, cause the one or more apparatuses to perform a method in accordance with any one of Clauses 1-30.

Clause 36: One or more computer program products embodied on one or more computer-readable storage media comprising code for performing a method in accordance with any one of Clauses 1-30.

Clause 37: One or more apparatuses configured for wireless communications, comprising: a processing system that includes one or more processors and one or more memories coupled with the one or more processors, the processing system configured to cause the one or more apparatuses to perform a method in accordance with any one of Clauses 1-30.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive, for a first uplink bandwidth part (BWP) that is an active uplink BWP of the UE, an indication of a virtual random access channel (RACH) configuration associated with one or more virtual RACH occasions (ROs);
receive a RACH configuration adaptation indication for the virtual RACH configuration, wherein the RACH configuration adaptation indication is associated with one or more additional ROs; and
perform one or more actions to initiate a RACH procedure, wherein the one or more actions comprise:
transmitting a random access message in a first additional RO of the one or more additional ROs; or
switching the active uplink BWP of the UE from the first uplink BWP to an initial uplink BWP and transmitting the random access message in an RO configured for the initial uplink BWP.

2. The apparatus of claim 1, wherein the processing system is configured to cause the UE to receive an indication to initiate the RACH procedure, wherein the one or more actions are performed based on the indication.

3. The apparatus of claim 2, wherein:
the indication to initiate the RACH procedure excludes any indication to use the one or more virtual ROs or the one or more additional ROs to initiate the RACH procedure; and
the one or more actions comprise transmitting the random access message in the first additional RO of the one or more additional ROs.

4. The apparatus of claim 2, wherein:
the indication to initiate the RACH procedure comprises an indication to use the one or more additional ROs to initiate the RACH procedure; and
the one or more actions comprise transmitting the random access message in the first additional RO of the one or more additional ROs.

5. The apparatus of claim 2, wherein:
the indication to initiate the RACH procedure comprises an indication to use the one or more virtual ROs to initiate the RACH procedure; and
the one or more actions comprise transmitting the random access message in the first additional RO of the one or more additional ROs.

6. The apparatus of claim 2, wherein:
the indication to initiate the RACH procedure comprises an indication to use the one or more virtual ROs to initiate the RACH procedure; and
the one or more actions comprise:
switch the active uplink BWP of the UE from the first uplink BWP to the initial uplink BWP; and
transmit the random access message in the RO configured for the initial uplink BWP.

7. The apparatus of claim 6, wherein the processing system is configured to cause the UE to:
receive, for the initial uplink BWP, an indication of a legacy RACH configuration associated with one or more legacy ROs comprising at least the RO.

8. The apparatus of claim 1, wherein the one or more processors are configured to cause the UE to:
based on the RACH configuration adaptation indication, adapt the virtual RACH configuration to activate at least the first additional RO of the one or more additional ROs.

9. The apparatus of claim 8, wherein:
the one or more virtual ROs comprise a plurality of virtual ROs;
the one or more additional ROs comprise a plurality of additional ROs;
each additional RO of a first subset of the plurality of additional ROs at least partially overlaps, in a time domain, with the plurality of virtual ROs;
a second subset of the plurality of additional ROs does not overlap, in the time domain, with the plurality of virtual ROs;
the first subset of the plurality of additional ROs or the second subset of the plurality of additional ROs comprises the first additional RO; and
to cause the UE to adapt the virtual RACH configuration, the processing system is configured to cause the UE to activate the first subset of the plurality of additional ROs and the second subset of the plurality of additional ROs.

10. The apparatus of claim 8, wherein:
the one or more virtual ROs comprise a plurality of virtual ROs;
the one or more additional ROs comprise a plurality of additional ROs;
each additional RO of a first subset of the plurality of additional ROs at least partially overlaps, in a time domain, with the plurality of virtual ROs;
a second subset of the plurality of additional ROs does not overlap, in the time domain, with the plurality of virtual ROs;
the second subset of the plurality of additional ROs comprises the first additional RO; and
to cause the UE to adapt the virtual RACH configuration, the processing system is configured to cause the UE to activate the second subset of the plurality of additional ROs and not activate the first subset of the plurality of additional ROs.

11. The apparatus of claim 8, wherein:
the one or more virtual ROs comprise a plurality of virtual ROs;
the one or more additional ROs comprise a plurality of additional ROs;
each additional RO of a first subset of the plurality of additional ROs overlaps, in a time domain and according to a first overlap type, a first subset of the plurality of virtual ROs;
each additional RO of a second subset of the plurality of additional ROs overlaps, in the time domain and according to a second overlap type, a second subset of the plurality of virtual ROs;
the first subset of the plurality of additional ROs comprises the first additional RO; and
to cause the UE to adapt the virtual RACH configuration, the processing system is configured to cause the UE to activate the first subset of the plurality of additional ROs and not activate the second subset of the plurality of additional ROs.

12. The apparatus of claim 8, wherein::
the first additional RO overlaps, in a time domain, a first virtual RO of the one or more virtual ROs; and
the first virtual RO is associated with a first synchronization signal block (SSB) index.

13. The apparatus of claim 8, wherein the processing system is configured to cause the UE to:
receive signaling that configures the UE to activate at least the first additional RO based on one or more conditions.

14. The apparatus of claim 1, wherein the one or more additional ROs are associated with one or more first association periods that are different than one or more second association periods associated with the one or more virtual ROs.

15. The apparatus of claim 1, wherein the one or more additional ROs and the one or more virtual ROs are both associated with one or more association periods.

16. A method of wireless communications by a user equipment (UE), comprising:
receiving, for a first uplink bandwidth part (BWP) that is an active uplink BWP of the UE, an indication of a virtual random access channel (RACH) configuration associated with one or more virtual RACH occasions (ROs);
receiving a RACH configuration adaptation indication for the virtual RACH configuration, wherein the RACH configuration adaptation indication is associated with one or more additional ROs; and
performing one or more actions to initiate a RACH procedure, wherein the one or more actions comprise:
transmitting a random access message in a first additional RO of the one or more additional ROs; or
switching the active uplink BWP of the UE from the first uplink BWP to an initial uplink BWP and transmitting the random access message in an RO configured for the initial uplink BWP.

17. The method of claim 16, further comprising:
receiving an indication to initiate the RACH procedure,
wherein the one or more actions are performed based on the indication.

18. The method of claim 17, wherein:
the indication to initiate the RACH procedure excludes any indication to use the one or more virtual ROs or the one or more additional ROs to initiate the RACH procedure; and
the one or more actions comprise transmitting the random access message in the first additional RO of the one or more additional ROs.

19. The method of claim 17, wherein:
the indication to initiate the RACH procedure comprises an indication to use the one or more additional ROs to initiate the RACH procedure; and
the one or more actions comprise transmitting the random access message in the first additional RO of the one or more additional ROs.

20. One or more non-transitory computer-readable media comprising executable instructions that, when executed by one or more processors of an apparatus, cause a user equipment (UE) to perform operations comprising:
receiving, for a first uplink bandwidth part (BWP) that is an active uplink BWP of the UE, an indication of a virtual random access channel (RACH) configuration associated with one or more virtual RACH occasions (ROs);
receiving a RACH configuration adaptation indication for the virtual RACH configuration, wherein the RACH configuration adaptation indication is associated with one or more additional ROs; and
performing one or more actions to initiate a RACH procedure, wherein the one or more actions comprise:
transmitting a random access message in a first additional RO of the one or more additional ROs; or
switching the active uplink BWP of the UE from the first uplink BWP to an initial uplink BWP and transmitting the random access message in an RO configured for the initial uplink BWP.
